(19) United States
(12) Patent Application Publication
(10) Pub. No.: US 2026/0359854 A1
(43) Pub. Date: Nov. 12, 2026

(54) PERSONALIZED PROMOTION GENERATION USING MACHINE LEARNING

(71) Applicant: DoorDash, Inc., San Francisco, CA (US)

(72) Inventors: Kun Hu, New York, CA (US); Charlie Furrer, San Francisco, CA (US); Akshat Khandelwal, New York, NY (US); Meghan Desai, San Bruno, CA (US); Paritosh Sharma, San Francisco, CA (US); Christopher Lanman, San Francisco, CA (US); Don Lee, Pacifica, CA (US); Nathan C Lemieux, New York, NY (US); Songjie Huang, Santa Clara, CA (US); Ze Ma, San Jose, CA (US)

(73) Assignee: DoorDash, Inc., San Francisco, CA (US)

(21) Appl. No.: 19/652,657

(22) Filed: Apr. 20, 2026

Related U.S. Application Data
(60) Provisional application No. 63/792,129, filed on Apr. 21, 2025.
(60) Provisional application No. 63/992,396, filed on Feb. 27, 2026.

(51) Int. Cl. G06Q 30/0207; G06Q 30/0211

(52) U.S. Cl. CPC G06Q 30/0224; G06Q 30/0211

(57) ABSTRACT

A method may be provided for generating optimized interaction amounts based on incremental interactions. For example, the method may involve obtaining data associated with users of a software application. The data may be indicative of orders placed by each of the users using the software application and resource providers associated with each of the orders. The method may further involve generating, based on the data, a user feature vector, inputting the user feature vector into a first machine learning model, and outputting, by the first machine learning model, a user-specific incremental interaction value for each of the users. Additionally, the method may involve generating, using a second machine learning model, incremental interaction values associated with frequency values. Moreover, the method may involve determining, based on the incremental interaction values associated with the order frequency values and based on the user-specific incremental interaction values, user-specific provider-specific incremental interaction values.

### CROSS REFERENCE TO RELATED APPLICATIONS

This application claims the benefit of U.S. Provisional Patent Application No. 63/792,129, filed on Apr. 21, 2025, and U.S. Provisional Patent Application No. 63/992,396, filed on Feb. 27, 2026, the entire contents of each of which are hereby incorporated by reference.

### BACKGROUND

Online platforms that facilitate interactions between end users and providers, often deploy communication campaigns to drive user engagement. But, traditional systems for managing such communications typical rely on rule-based heuristics, such as static rules for new users, and basic segmentation models, which are limited in their ability to personalize communications and adapt to evolving user behavior and external factors. These limitations lead to inefficient allocation of messages, suboptimal return on such communications, and poor scalability when attempting to customize communications at the individual user or provider level. Accordingly, there exists a need for automating, scaling, and optimizing the generation, targeting, and delivery of communications in large, data-rich environments.

### SUMMARY

Embodiments are related to methods and systems for generating optimized interaction amounts using machine learning. One embodiment is related to a method. The method may involve obtaining data associated with users of a software application, the data indicative of orders placed by each of the users using the software application and resource providers associated with each of the orders; generating, based on the data, a user feature vector for each of the users; inputting each of the user feature vectors into a first machine learning model; outputting, by the first machine learning model, a user-specific incremental interaction value for each of the users; generating, using a second machine learning model, an incremental interaction value for each of a set of order frequency levels; and determining, based on the incremental interaction values for each of the set of order frequency values and based on the user-specific incremental interaction values for each of the users, a plurality of user-specific provider-specific incremental interaction values.

Another embodiment is related to a computer comprising: a processor; and a computer-readable medium coupled to the processor, the computer-readable medium comprising code executable by the processor for implementing any of the preceding methods.

Further details regarding embodiments of the disclosure can be found in the Detailed Description and the Figures.

### BRIEF DESCRIPTION OF THE DRAWINGS

FIG. 1 shows a block diagram of an example of a computing environment for generating optimized interaction amounts based on incremental interactions according to some embodiments of the present disclosure.

FIG. 2A shows a first plot of aggregated user-specific return on advertising spend (ROAS) values against sensitivity percentiles for unsubscribed users of a software application.

FIG. 2B shows a second plot of aggregated user-specific ROAS values against sensitivity percentiles for subscribed users of the software application.

FIG. 3 shows a plot of predicted ROAS values against order frequency levels.

FIG. 4A shows a first section of a table of consumer-specific, provider-specific ROAS values for unsubscribed users of the software application.

FIG. 4B shows a second section of the table of consumer-specific, provider-specific ROAS values for unsubscribed users of the software application.

FIG. 5A shows first section of a table of consumer-specific, provider-specific ROAS values for subscribed users of the software application.

FIG. 5B shows a second section of the table of consumer-specific, provider-specific ROAS values for subscribed users of the software application.

FIG. 6 is a flowchart illustrating a method for modeling incremental interactions at a relatively high level of granularity according to some embodiments of the present disclosure.

FIG. 7 is a flowchart illustrating a method for constrained optimization using an objective function according to some embodiments of the present disclosure.

FIG. 8 is a flowchart illustrating a method for constrained optimization using incremental interactions according to some embodiments of the present disclosure.

FIG. 9 shows an example architecture and flow of a hard cap system according to some embodiments of the present disclosure.

FIG. 10 shows a block diagram of a system according to some embodiments of the disclosure.

FIG. 11 shows a block diagram illustrating a central server computer according some to embodiments of the present disclosure.

FIG. 12 shows a block diagram illustrating a computer system according to some embodiments of the present disclosure.

### TERMS

Prior to discussing embodiments of the disclosure, some terms can be described in further detail.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

The term “resource” can include any asset that may be used or consumed. For example, the resource may be an electronic resource (e.g., stored data, received data, a computer account, a network-based account, an email inbox), a physical resource (e.g., a tangible object, a building, a safe, or a physical location), or other electronic communications between computers (e.g., a communication signal corresponding to an account for performing a transaction).

A “resource provider” may be an entity that can provide a resource such as goods, services, information, and/or access. Examples of resource providers includes merchants, data providers, transit agencies, governmental entities, venue and dwelling operators, etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc. Transporters can also include autonomous vehicles such as self-driving cars and unmanned drones.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods, For example, bowls of soup, soda cans, toys, clothing, etc. An item can be delivered from a service provider location to an end user location by a transporter.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “training set of training samples” can include a set of data used for training. A training set of training samples can include a plurality of training samples.

A “training sample” can include data used to train a model. A training sample can include a vector, or other data structure. A training sample can include access request data.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### DETAILED DESCRIPTION

Finding an optimal interaction amounts across diverse user and resource provider cohorts in digital platforms, digital marketplaces, software applications, or the like presents several interrelated technical challenges. For example, traditional approaches for determining targeted communication campaigns that drive user engagement with digital platforms, digital marketplaces, or software application may do so through providing discounts to new users, prioritizing frequent users, or favoring popular resource providers (e.g., merchants). But, the traditional approaches to determining targeted campaigns typically rely on static heuristics that cannot capture the complexity and dimensionality of modern user interactions within digital platforms, digital marketplaces, or software applications. Furthermore, the traditional approaches to determining targeted campaigns typically struggle with segmentation across numerous attributes, such as order recency, subtotal, subscription status, cannot personalize discount amounts, and fail to adapt dynamically as user and provider behaviors evolve. As a result, the traditional strategies for determining targeted campaigns often produce suboptimal segmentation, inefficient promotional spending, and high incremental costs per order, ultimately resulting in poor return on advertising spend.

Embodiments of the present disclosure overcome the above issues by introducing a ML-driven system that powers communication campaigns with ML-driven promotions, advertisements, and discounts. To power the communication campaigns, the system may utilize advanced causal modeling and optimization to predict and optimize incremental interactions, such as incremental order spending per $1 discount across users, resource providers, and user-provider pairs. The users, resource providers, and user-provider pairs may be associated with a digital platform or software application (e.g., a digital delivery platform). By predicting and optimizing for incremental order spending per $1 discount across the users, resource providers, and user-provider pairs, the system enables dynamic interaction targeting and personalized interaction values, such as dynamic and personalized discounts and promotional offers.

However, it may be computationally expensive to predict and optimize incremental interactions across digital platforms, digital marketplaces, or software applications at a high level of granularity. For example, it can be computationally expensive to predict and optimize incremental interactions at the levels of individual users, individual resource providers, and user-provider pairs. Moreover, due to the relatively high granularity required of outputting custom interaction amounts at the user-level, provider-level, and user-provider pair level, outputs may have high variance and be unreliable. The system also must mediate between conflicting objectives, such as maximizing profit at both individual resource provider levels and higher levels, such as across all resource providers. Moreover, the system must mediate between such conflicting objections while satisfying various constraints, such as resource provider- or marketplace-defined budget limits.

To ensure that the system performs high-granularity incremental modeling with reduced latency and increase computation efficiency, the system can decompose the modeling problem into a multi-step approach involving modular components. That is, rather than relying on a single, monolithic model prone to instability and high variance, the system can decompose the highly-granular modeling into separately executed machine learning models. The system may then utilize the estimated incrementality at the user level, at the resource provider level, and user-provider pair level in a multi-layered and simplified process. Such decomposition therefore enables the system to generate robust, low-latency predictions at a high level of generality, even as the number of possible combinations scales.

The issue of optimization under constraints may be addressed by ensuring constraint awareness during the multi-step approach. To do so, the system may generate robust training data, for example, through randomized holdout experiments in which subsets of users are exposed to controlled communication campaigns. Machine learning models may then be trained using the training data to estimate incrementality. After training, incrementality outputs of the machine learning models can be combined with behavioral cohort data, such as data indicative of user interaction frequency with a resource provider via a digital platform, digital marketplace, or software applications, to compute predicted incremental interaction values for each user, provider, or user-provider pair. The system may then implement constrained optimization algorithms, such as ex post sequential selection and grid search, capable of maximizing cumulative incremental amounts, such as spending on a promotion provided to one or more users via the digital platform, digital marketplace, or software application, while enforcing limits at the provider or multi-provider level.

Additionally, to balance and address conflicting objectives, the system may incorporate an optimization framework with configurable parameters that can be adjusted at the provider or digital marketplace level to dynamically shift between efficiency-oriented and growth-oriented strategies. An efficiency-oriented strategy may involve, at a provider level or multi-provider level, maximizing user interactions via the digital marketplace, digital platform, or software application.

Conversely, growth-oriented strategies may involve, at a provider or multi-provider level, maximizing a number of users interacting with the provider or multiple providers via the digital marketplace, digital platform, or software application. The configurable parameters may be weighting coefficients (e.g., lambda values) in an objective function that quantitatively represent the relative importance assigned to the different strategies. The parameters can be adjustable globally (across the digital marketplace) or locally (at an individual provider level). This, in turn, enables the system to dynamically shift its operational focus between efficiency-oriented strategies, which may maximize net sales or profitability for providers, and growth-oriented strategies, which emphasize increasing, for example, order volume across a digital marketplace.

Additionally, traditional systems for determining targeted communication campaigns in online marketplaces are fundamentally limited in their ability to adapt to real-world dynamics. For example, the traditional systems often operate by configuring fixed rules, such as a daily or campaign-level caps, eligibility thresholds, or pre-set pacing schedules. But, such fixed rules inherently lack responsiveness to user interactions within a digital marketplace or software application. Moreover, the traditional systems tend to rely on offline reporting and manual intervention for feedback. As a result, in traditional systems, the fixed rules are typically updated on a daily or weekly basis, further increasing the latency in employing useful and up-to-date rules.

An additional technical challenge is that observed campaign outcomes are subject to stochastic variation. Such inherent randomness in campaign interaction or user by users can cause short-term deviations from targets that are not indicative of systemic error, but rather reflect normal statistical noise. Observed promotional outcomes may also be subject to delayed attribution, such as a lag between when a campaign is served (e.g., a customer sees an offer or redeems a code via a software application) and when an associated interaction (e.g., a sale) is recorded and attributed. As a result of such delayed attribution, interaction data may be incomplete. Moreover, the process of tracking user interactions across a digital marketplace or software application is often subject to errors and inconsistencies. For instance, data pipelines may drop events, apply inconsistent deduplication logic, or experience backfill delays.

These technical challenges of stochastic variation, delayed attribution, and inaccurate user interaction tracking can collectively create a “noisy” control environment, where feedback mechanisms for adjusting campaign targets, such as total-to-conversion targets, can do more harm than good. For example, a system can cause instability, oscillatory behavior, or over-correction if it adjusts total-to-conversion targets too quickly in response to deviations from previous total-to-conversion targets.

Embodiments of the present disclosure address the above mentioned limitations by introducing a dynamic, feedback control mechanism that enables providers to pursue varying campaign objectives, such as user interaction maximization, while ensuring compliance with constraints. Unlike static rule-based or offline approaches, the feedback control mechanism can continuously adapt to real-time user interactions by maintaining tunable eligibility parameters that jointly regulate each provider's total-to-conversion ratio. The eligibility parameters may be related to an intensity of a discount, a breadth of user eligibility for a discount, or a combination thereof.

Notably, the closed-loop control mechanism can involve periodically feeding observed campaign outcomes back into the above described optimization processes. For example, on a daily basis, a batch processing pipeline may compute a resource provider's total-to-conversion ratio over a previous period of time, such as a previous seven days, and compares the total-to-conversion ratio to the provider-specific target. The system may then perform a multi-stage update process in which it calculates an error by measuring a gap between the target total-to-conversion ratio and actual total-to-conversion ratio. The error may be calculated independently for each campaign channel, such as each type of campaign. Next, the system may apply noise-adaptive attenuation by using signal-to-noise ratio (SNR) weighting to scale a correction magnitude based on historical volatility in the provider's total-to-conversion ratio, which may be based on the provider's size. In this way, the system can prevent overreactions to insignificant fluctuation in user interactions.

Once the error is attenuated, the system may update the eligibility parameters proportionally, leveraging a sensitivity coefficient that has been empirically estimated through controlled experiments. The updated eligibility parameters may be persisted to a feature store, where they can be accessed by predictive models during the a next cycle of campaign generation, thereby closing the feedback loop and ensuring continuous, data-driven adjustment of promotional spending.

In one example, a first step of the multi-step approach described herein involves executing a large-scale randomized holdout experiment in which a subset of users are provided one or more campaigns, via a software application, that involve $X off $Y minimum orders. The experiment, in turn, creates robust labeled training data of user interactions across many user-provider pairs associated with the software application. In another example, training data may be obtained based on user interactions with the software application (e.g., orders placed on the delivery application) and campaigns provided to and/or used by the user via the software application.

A next step may involve causal modeling and sensitivity scoring using the training data. For example, using the training data, causal inference models, such as meta-learners, double ML, causal forests, or the like, may be trained and executed to estimate interaction incrementality. The estimated interaction incrementality may be a predicted difference in interaction probability or interaction dollar amount with and without a campaign. The causal inference models may further output a sensitivity score for each user, each resource provider, each user-provider pair, or a combination thereof. The sensitivity score may be based on the estimated difference in interaction probability or interaction amount for the user depending on whether a promotion is provided. Thus, the sensitivity score may indicate how sensitive a user is to campaigns, which may be used to rank campaign efficacy and target users with effective campaigns.

The sensitivity scores may then be combined with data indicative of cohort behavior. Examples of data indicative of cohort behavior include a past 90-day user interaction frequency and average interaction volume per provider. As a result of combining the sensitivity scores with the data indicative of cohort behavior, incremental interaction values for user-provider pairs can be calculated. The incremental interaction values for user-provider pairs may be an estimated spending by a user per dollar spent by a resource provider on a campaign. For example, an incremental interaction value may be 1.05, thereby indicating that the user is predicted to spend $1.05 for each $1 received on a campaign.

Accordingly, user-provider pairs may be filtered and assigned customized campaign values (e.g., $X off $Y minimum orders) based on the incremental interaction values and based on provider-level constraints. For example, optimization algorithms may be implemented via heuristic and constrained formulations, such ex post sequential selection, to provide optimal campaigns to user's while ensuring budget efficiency at the provider level. Targeting tags and optimized discount amounts may then be provided daily to users using the software application and online feature stores. Moreover, the predictions, such as the predictions of the incremental interaction values for user-provider pairs, may be served in real time and integrated into downstream promotion delivery systems (e.g., CHS, AdEx).

Accordingly, the above-described system can facilitate efficient and effective campaign targeting and development by maximizing incremental orders and sales per promotion dollar. Moreover, the above-described system can facilitate personalization of campaigns by predicting, optimizing, and tailoring both who receives a campaign and how much the campaign provides at a high level of granularity that involves both users and resource providers. The system can further enable massive scalability of the solution (~billions of user-provider pairs) through cohosting and decomposition techniques and flexibility as the system can adapt to provider goals (growth vs. profit) and co-funding strategies. The system further provides a dynamic solution to efficient campaign formulation as the system may re-optimize in response to user behavior and constraint changes.

Furthermore, modern online marketplaces, digital platforms, and associated software applications must routinely manage, process, and respond to massive streams of data generated by millions of users and resource providers in real time. However, traditional systems for generating and implementing targeted campaigns within these environments are typically built upon static, rule-based engines and batch-oriented data pipelines. Such computing architectures are inherently limited in their ability to support the demands of dynamic, high-volume, and latency-sensitive applications. This, in turn, leads to inefficiencies and technical bottlenecks for the online marketplaces, digital platforms, and associated software applications, including high latency, limited scalability, and an inability to adapt to rapidly changing user and provider (e.g., merchant) behavior.

For example, the traditional system's tendency to rely on scheduled batch jobs for data aggregation and rule evaluation introduces significant latency between the occurrence of user actions and the system's ingestion of data for generation of campaigns. Similarly, feedback mechanisms, such as the collection and analysis of campaign performance metrics, are often implemented in an offline or delayed fashion. These delays prevent the traditional systems from adapting effectively to changes in user or provider behavior and result in utilization of unreliable or stale data.

Furthermore, the rule-based logic is inflexible and therefore cannot scale efficiently as the number of users, providers, and campaign parameters grows. For example, rule-based logic requires explicit enumeration of each scenario the system must handle. Thus, as the number of users, providers, and campaign types in a digital marketplace increases, a corresponding rule set grows exponentially, making maintenance, updates, and expansion computationally inefficient and error-prone. Moreover, static rules cannot adapt to changes in user behavior, provider offerings, or online marketplace dynamics without manual intervention and redeployment, which is both slow and computing resource-intensive. Accordingly, the tendency of traditional systems to rely on scheduled batch processing and rule evaluation causes current systems for generating or evaluating campaigns to suffer from latency, computational bottlenecks, and inefficient computing resource consumption.

The present disclosure provides a technical solution that directly addresses and overcomes the limitations of traditional, rule-based, and batch-oriented systems described above. Specifically, aspects of the present disclosure include a system that fundamentally improves computer functionality for the allocation, targeting, and delivery of personalized campaigns in large-scale, data-rich environments. For example, rather than relying on static rule sets and scheduled batch processing, which inherently introduce high latency, bottlenecks, and inflexibility, the system leverages a modular, machine learning-driven architecture that decomposes the complex technical problem of campaign allocation into multiple specialized models. These models operate at distinct granularities (e.g., user-level, provider-level, and user-provider pair level), enabling parallel and efficient processing of massive streams of transactional and behavioral data as the data is generated. Moreover, by employing causal modeling, real-time data ingestion pipelines, and closed-loop feedback mechanisms, the system is able to produce robust and low-latency predictions, dynamically optimize incremental spending per promotional dollar, and adapt to changing user and provider behaviors with a degree of agility not possible in legacy systems.

For example, the system constructs user feature vectors from continuously ingesting behavioral and transactional data from the online marketplaces, digital platforms, and associated software applications, and then processes the user feature vectors through up-to-date, trained machine learning models to output user-specific incremental interaction values. The system may further compute incremental interaction values for resource providers and combine these with user-specific incremental interaction values to determine user-specific, provider-specific incremental interaction values. The user-specific, provider-specific incremental interaction values can quantify a predicted increase in user spending per promotional dollar with respect to a given provider to facilitate highly granular customization of campaign allocation. Unlike traditional architectures, where batch jobs and static rules cause significant delays and resource waste, the system employs optimization algorithms (such as grid search) that operate on these dynamically generated user-specific, provider-specific incremental interaction values to allocate custom campaigns in near real time. Thus, this machine learning-driven approach reduces latency, eliminates the computational inefficiency of manually enumerated rule sets, and prevents the propagation of stale or unreliable data throughout the system.

Additionally, through the use of computationally efficient optimization functions and real-time ranking mechanisms, the system can scale seamlessly to the number of users, providers, and campaign parameters associated with a given digital platform, marketplace, or the like.

Consequently, the system avoids the exponential increase in rule complexity and system maintenance burdens that hinder traditional solutions. The system can further ensure adaptability through the mechanisms for real-time ranking of users, cumulative campaign spend tracking, and eligibility updates, which are supported by periodic retraining of machine learning models and real-time data pipelines utilizing distributed databases (e.g., Redis or Cassandra). For example, by employing user ranking, the system leverages up-to-date behavioral and transactional data to dynamically prioritize users for campaign delivery, ensuring that computational decisions are made efficiently and based on up-to-date user information. This real-time ranking can be facilitated through high-throughput data pipelines and distributed computing, which can allow the system to continuously ingest, process, and analyze streams of data at scale without the delays associated with batch processing.

Moreover, the system's ability to track cumulative campaign spend enables precise monitoring and enforcement of constraints at the provider level, preventing overspending through instantaneous aggregation and evaluation of campaign activity. Eligibility updates can similarly be performed in real time or near real-time, with eligibility flags persisted in low-latency databases and updated at frequent intervals (e.g., every 10 minutes) to thereby allow the system to quickly suppress or re-enable campaigns for individual providers as conditions in digital platforms or marketplaces change.

Together, the above-described technical features support low-latency operations by minimizing the delay between user actions, system analysis, and campaign response, and enable immediate feedback loops that ensure the system remains adaptive to evolving digital marketplace dynamics. The integration of these real-time or near-real time mechanisms with modular machine learning models and optimization algorithms further enhances system throughput and responsiveness, providing a scalable and robust foundation for personalized campaign generation in large, data-rich environments.

### I. System Architecture

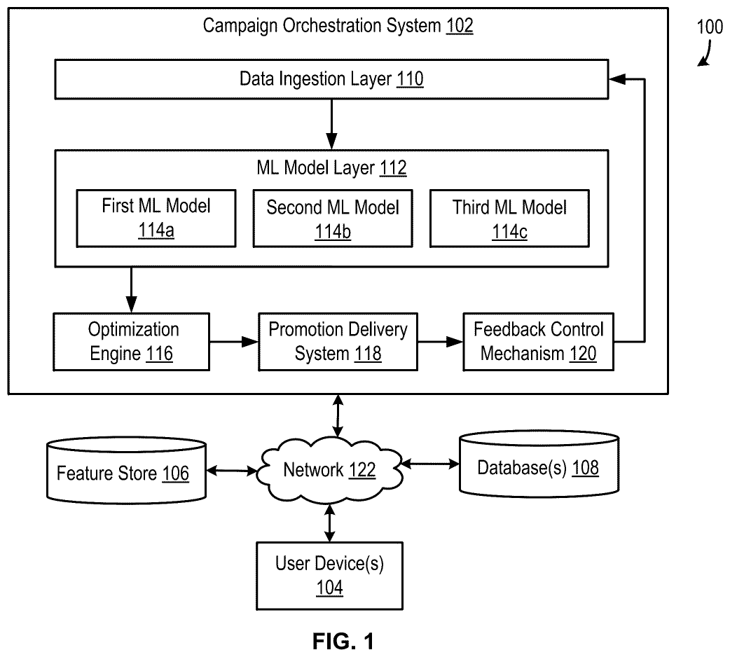

FIG. 1 shows a block diagram of an example of a computing environment 100 for generating optimized interaction amounts based on incremental interactions according to some embodiments of the present disclosure. The computing environment 100 may be a distributed computing system, and may include a orchestration system 102, database(s) 108, feature store 106, and user device(s) 104, which may be communication with one another over one or more networks (e.g., network 122). Examples of the one or more networks can include a local area network (LAN), wide area network (WAN), the Internet, or any combination thereof. Although the databases 108 and feature store 106 are shown as separate from and communicatively coupled with the orchestration system 102, the databases 108, the feature store 106, or the combination thereof may be part of the orchestration system 102 in other examples.

The orchestration system 102 may include various computing components, such as servers or other computing devices, for generating optimized interaction amounts based on incremental interactions. For example, a data ingestion layer 110 may be communicatively coupled to the user devices 104 and may serves as an entry point for incoming data streams. The data ingestion layer 110 may therefore include hardware and/or software components responsible for collecting, normalizing, and validating heterogeneous data from disparate sources, such as disparate user devices executing an online marketplace or associated software application. The data ingestion layer 110 supporting both real-time streaming (e.g., via Apache Kafka or AWS Kinesis) and batch processing.

In one example, the data ingestion layer 110 can obtain, from the user devices 104, data associated with users of a software application. The software application may be associated with an online marketplace for facilitating delivery services. Thus, the data may be indicative of orders placed by the users using the software application, where each of the orders is associated with a resource provider, such as an organization, merchant, or the like.

The orchestration system 102 may further generate, based on the data obtained by the data ingestion layer 110, a user feature vector for each of the users. A user feature vector may be a set of quantifiable attributes or characteristics (features) extracted from data ingested by the data ingestion layer 110. The features of a user feature vector may be ingestible by a ML model layer 112 of the orchestration system 102 to serve as inputs to machine learning (ML) models 114a-b.

To generate the user feature vectors, the orchestration system 102 may extract and aggregate a set of measurable properties that characterize a user's historical behavior and interactions with the a digital marketplace or software application. For example, due to the ingestion of data by the data ingestion layer 110, the orchestration system 102 can have access to information about each user's behavior and interactions with the digital marketplace or software application. Such information may include a number of non-discounted orders placed over defined time frames (e.g., the previous 7, 30, 90, or 365 days) by the users, a number of days the users accessed the software application, a number of days with completed orders to the users, and conversion rates (i.e., the ratio of days with orders to days with access) of the user's. The information may then processed, such as by being normalized or encoded, to form structured numerical arrays or vectors, which can be referred to herein as the user feature vectors.

Once generated, the user feature vectors may be stored in the feature store 106. The feature store 106 may be a centralized, high-availability repository that stores, organizes, and manages features and user feature vectors derived from raw data inputs. The feature store 106 can support both historical and real-time feature access for the orchestration system 102 to thereby provide low-latency data retrieval for both model training and inference.

Moreover, the ML model layer 112, as shown in FIG. 1, encompasses multiple machine learning (ML) models 114a-c that can process feature vectors to generate predictions and classifications relevant to campaign (promotional) targeting. In the example shown, the ML model layer 112 includes a first ML model 114a for user-level incrementality prediction, a second ML model 114 for predicting incrementality based on order frequency levels, and a third ML model 114c for campaign prediction. These models may include supervised and/or unsupervised algorithms such as neural networks, decision trees, or ensemble methods.

Accordingly, in the example, the orchestration system 102 may input user feature vectors for the users into the first machine learning (ML) model 114a. As a result, the orchestration system 102 can output, by the first ML model 114a and based on the user feature vectors for the users, a user-specific incremental interaction value for each of the users. The orchestration system 102 may also generate, using the second machine learning model 114b, an incremental interaction value for each of a set of order frequency levels for resource providers. The resource providers may be the resource providers associated with the orders placed by the users.

The orchestration system 102 may then determine, based on the incremental interaction value for each of the set of order frequency values for each resource provider and based on the user-specific incremental interaction values for each of the users, user-specific provider-specific incremental interaction values. For example, for a certain resource provider and a certain user, the orchestration system 102 can determine, based on the data ingested by the data ingestion layer 110, a order frequency of the user for the resource provider (e.g., a number of orders the user has placed with the resource provider via the software application over a previous time period, such as 90 or 180 days). The orchestration system 102 may then multiply the incremental interaction value generated by the second ML model 114b for that order frequency by the incremental interaction value generated by the first ML model 114a for the user to obtain a user-specific provider-specific incremental interaction value for the certain user with respect to the certain resource provider.

As shown in FIG. 1, coupled to the ML model layer 112 is an optimization engine 116. The optimization engine 116 may be a collection of software modules responsible for determining optimal interaction amounts for each user relative to the resource providers. The software modules may utilize grid search or other constrained optimization methods to select and prioritize promotional offers based on objectives such as maximizing net sales, user engagement, or adherence to budgetary limits. The optimization engine 116 may also responsible for generating rankings of users and calculating cumulative promotion spending to ensure compliance with budget constraints.

In the example, the orchestration system 102 may execute, by the optimization engine 116, a grid search to determine an optimal interaction amount for each of the users relative to each resource provider based on the plurality of user-specific provider-specific incremental interaction values. The optimal interaction amount may be an amount for a provider to spend on a promotion provided to a user to maximize profit or sales associated with the user. After determining the optimal interaction amounts for each of the users, the optimization engine 116 can generate a ranking of the users relative to each resource provider. The ranking may be based on the user-specific provider-specific incremental interaction values, the optimal interaction amounts, an objective value, or a combination thereof. The objective value may be a quantitative score or metric used to assess and compare the effectiveness of possible promotional offers (i.e., interaction amounts) for users with respect to a specific resource provider.

Moreover, the optimization engine 116 can calculate a cumulative interaction value for a subset of highest ranked users based on the ranking of the users relative to each resource provider. The cumulative interaction value may be calculated with respect to one resource provider or a set of resource providers. The cumulative interaction value may be calculated by adding the optimal interaction amount starting from a highest ranked user for the provider or set of providers. The cumulative interaction value may be subject to a constraint. Thus, the optimal interaction amounts can be added until the cumulative interaction value is relatively close to or equal to the constraint.

The users associated with the added optimal interaction amounts may then be users that are provided with individual amounts. The individual amounts may be, for example, personalized discounts or promotional values, such as buy one get one or spend X get Y promotion. In some examples, the third ML model 114c may be used to translate the incrementality metrics, optimal interaction amounts, or the like into concrete, actionable offer amounts on a per-user basis. To do so, the third ML model 114c may receive the previously generated user-specific incremental interaction values, the user-specific provider-specific incremental interaction values, the optimal promotional amounts, or the like as features, along with additional contextual or operational data. Consequently, the third ML model 114c can output individual amounts for user and resource provider pairs.

Notably, the third ML model 114c may operate under the guidance of one or more hyperparameters that may collectively define constraints or goals for the overall allocation of promotional value across users. The hyperparameters may include, but are not limited to, a maximum amount or a ratio of a conversion amount to the total amount (e.g., a budget cap for promotions provided the resource provider or a target spend-to-sales (STS) ratio). By conditioning outputs on these hyperparameters, the third ML model 114c can ensure that the sum of individual amounts remains compliant with provider constraints, such as resource provider budget limits.

In some examples, the orchestration system 102 may clip changes in the hyperparameters to one or more maximum changes, where the changes may occur from one time period to a next time period. Clipping, in this context, may refer to the process of constraining the degree to which hyperparameters, such as eligibility thresholds, spending limits, or ratios used in promotional offer calculations, can be increased or decreased between consecutive evaluation intervals (e.g., daily or hourly system updates). By imposing a hard boundary on the allowable adjustment for each hyperparameter, the orchestration system 102 can effectively prevent abrupt or excessive hyperparameter swings that might otherwise result from outlier events, noise, or short-term volatility in underlying data.

As individual amounts are generated, the delivery system 118 can orchestrate real-time dissemination of personalized campaign (promotional) content to the user devices 104. This delivery system 118 may include APIs, notification services, and messaging platforms that ensure timely, relevant, and contextually appropriate delivery of promotional offers via software applications, digital platforms, online marketplaces, or the like. The delivery system 118 may also manage content personalization, multi-channel delivery strategies, and compliance with user preferences and regulatory requirements.

Additionally, a feedback control loop 120 may continuously monitor user responses to delivered promotions and routes the feedback back into the data ingestion and feature engineering pipelines. The feedback control loop 120 may enable real-time adjustment of eligibility parameters and hyperparameters (e.g., conversion-to-total or spend-to-sales (STS) ratios). Consequently, via the feedback control loop 120, the orchestration system 102 can dynamically refine the ML models 114a-c and delivery strategies based on observed outcomes.

Furthermore, in some examples, the orchestration system 102 can perform dynamic control and suppression of promotional offers to users based on cumulative spending or conversion activity relative to a resource provider. For example, the orchestration system 102 may suppress the individual amount offered for each user associated with a given provider when a cumulative amount, such as cumulative promotional spending or total conversion-related outlay, reaches a disable threshold. The orchestration system 102 may do so by preventing the individual amount from being offered via a software application or digital platform. The disable threshold may be a dynamically configured threshold that is based on a statistical analysis of historical total-to-conversion ratios (such as spend-to-sales or promotion-to-order ratios) for a resource provider. By analyzing historical data, the orchestration system 102 can calculate an average total-to-conversion ratio and determine the disable threshold as a selected number of standard deviations above the average.

The orchestration system 102 can also implement a mechanism for re-enabling the individual amounts. For example, re-enablement occurs only after the cumulative amount falls below a re-enable threshold, which is set lower than the disable threshold. This dual-threshold design can ensure that promotional delivery is not repeatedly and erratically enabled and disabled due to minor fluctuations in cumulative amounts.

To support this dynamic control, the cumulative amount can be aggregated in real time from ongoing conversion events, such as orders, redemptions, or other qualifying transactions within a digital marketplace, digital platform, or software application. Eligibility for offering individual amounts may be updated at a periodic interval, such as every 10 minutes, based on the latest aggregated data. This periodic update can allow the orchestration system 102 to quickly respond to changes in user or provider activity.

Moreover, the orchestration system 102 can persist an eligibility flag for each resource provider in a distributed, high-availability database, which may be included in the databases 108. The eligibility flag can act as a deterministic criterion within the promotional serving path provided by the delivery system 118. Thus, as an example, if the flag indicates ineligibility, such as when the cumulative amount exceeds the disable threshold, the delivery system 118 can automatically suppresses any automated promotional recommendations for that provider, regardless of other model predictions.

### II. Modeling Incremental Interactions at a High Level of Granularity

It may be desirable to optimize promotion generation and availability at the user-level (e.g., for each user associated with a software application), provider-level (e.g., for each resource provider associated with a software application), and user-provider pair level (e.g., for each user-provider pair). However, it may be computationally expensive to generate and execute a singular model that outputs customized promotions based on each user associated a software application, each resource provider (e.g., restaurant or merchant) associated with the software application, and each user-provider pairing. Moreover, due to the relatively high granularity required of outputting custom promotions at the user-level, provider-level, and user-provider pair level, outputs of the singular model would likely have high variance and be unreliable.

Accordingly, improve a reliability of custom promotion outputs (e.g., user-specific, provider-specific discounts) and reduce latency in generating the custom promotion outputs, the model may be decomposed into components associated with each of the user-level, provider-level, and user-provider level. For example, a first component, which may be a first model, may output an estimated incrementality per user. The estimated incrementality may be an estimated return on advertising spend (ROAS) value. In other words, the estimated incrementality per user may provide an estimated increase in spending by the user per dollar received by the user in promotions.

Then, a second component, which may be a second model, may output an estimated incrementality per user-provider pair. The estimated incrementality per user-provider pair may provide an estimated increase in spending at a resource provider by the user per dollar received by the user in promotions from the resource provider. Moreover, a third component, which may be a third model, may output an estimated incrementality for a promotion. For example, the third component may output an estimated increased in profit per dollar spent per resource provider.

### A. Modeling Incremental Interactions at the Consumer Level

In an example, data for a cohort of users of a software application (e.g., a delivery application) may be obtained. The data may be associated with an experiment in which a first subset of the cohort of user's (e.g., 5% of the users) did not receive promotions (e.g., discounts) and a second subset of the cohort of user's (e.g., 95% of the users) received promotions. The data may indicate, for each user, purchases made both with and without the promotions.

Moreover, a user feature vector associated with each user may be generated based on the data. Features included in the user feature vector may include a number of non-discounted orders over a time frame (e.g., a previous 7, 30, 60, 90, 150, 200, 250, 300, or 365 days or any number of days therebetween), a number of days in which the user accessed the software application over a time frame, a numbers of days with orders over a time frame, a conversion rate (e.g., a ratio of the number of days with orders to the number of days with access), an average discount per order per user over a time frame, a number of orders from dimension deliveries, no filter, over a time frame, an average subtotal for orders placed over a time frame, consumer tenure in days (how long person has been a user), a measure of how many orders a user places per resource provider or per set of resource providers, a variance of post-discount subtotal per user over a time frame, a percentage of non-discounted orders over a time frame, an indicator of whether a user is a subscriber to the software application, other features obtainable from the data, or a combination thereof.

The user feature vector for each user may then be input into a machine learning model. The machine learning model may be executed to determine a user-specific ROAS value for each user. That is, the machine learning model may output an estimated increase in spending by the user per dollar received by the user in promotions. The machine learning model may include a light GVM model, another tree-based machine learning model, a neural network, a support vector machine, a logistic regression model, a linear regression model, other type of machine learning models, or a combination thereof.

In some cases, the machine-learning model may be initially trained using a set of training data. For example, the data for the cohort of users of the software application may be split into a training dataset and a testing data set. The machine-learning model may be trained using the training dataset that includes data for orders placed by a first subset of the users with and without promotions. The trained machine learning model may be checked for accuracy using the testing data set and may then be deployed for use in determining user-specific ROAS values. The machine-learning model may be periodically updated and re-trained based on new training data to keep the machine-learning model up-to-date and accurate.

In one example, a double machine learning model may be implemented such that the machine learning model may perform two steps. In a first step, the machine learning model may predict, based on the user feature vectors, an amount each user spends on orders placed with the software application without a promotion and an amount each user spends on orders placed with the software application with a promotion. In doing so, the machine learning model may generate a delta representative of a difference between the amount a user orders without a promotion and with a promotion. Then, in a second step, the machine learning model may generate and output the user-specific ROAS value (e.g., the estimated increase in spending by the user per dollar received by the user in promotions).

In the example, the output of the machine learning model is normalized such that the average user-specific ROAS value output by the machine learning model is 1. Consequently, the output of the machine learning model may be a predicted ROAS value that indicates, for each $1 discount received, how much would each user is predicted to increase spending on an order as a percentage. For example, a user-specific ROAS value may be 1.05 (e.g., 105%), thereby indicating that the user is predicted to spend $1.05 for each $1 received in promotions. Therefore, the machine learning model provides, for each user, an indication of the user's sensitivity to promotions. For example, users that are predicted to spend relatively higher amounts per $1 discount may be deemed more sensitive than users predicted to spend relatively lower amounts per $1 discount.

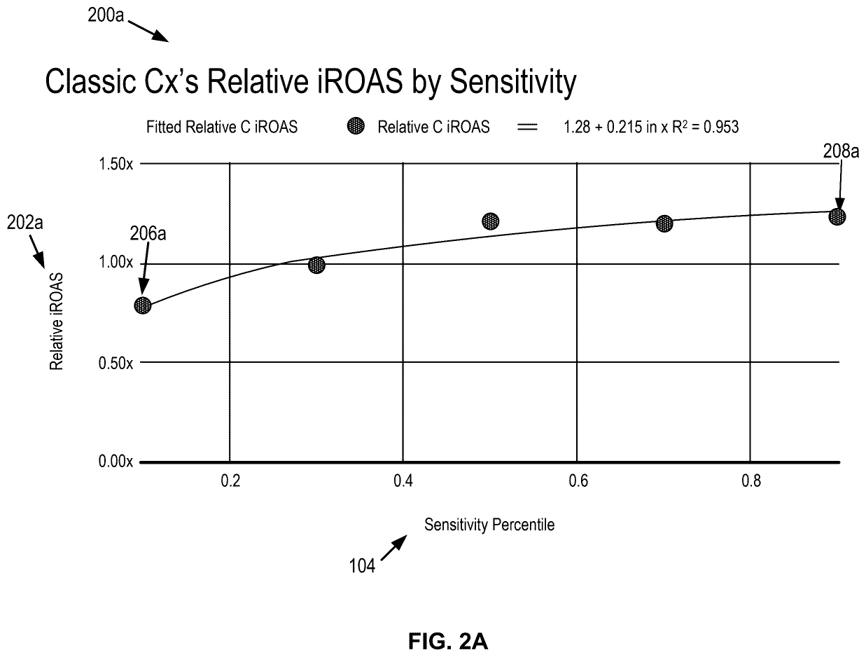

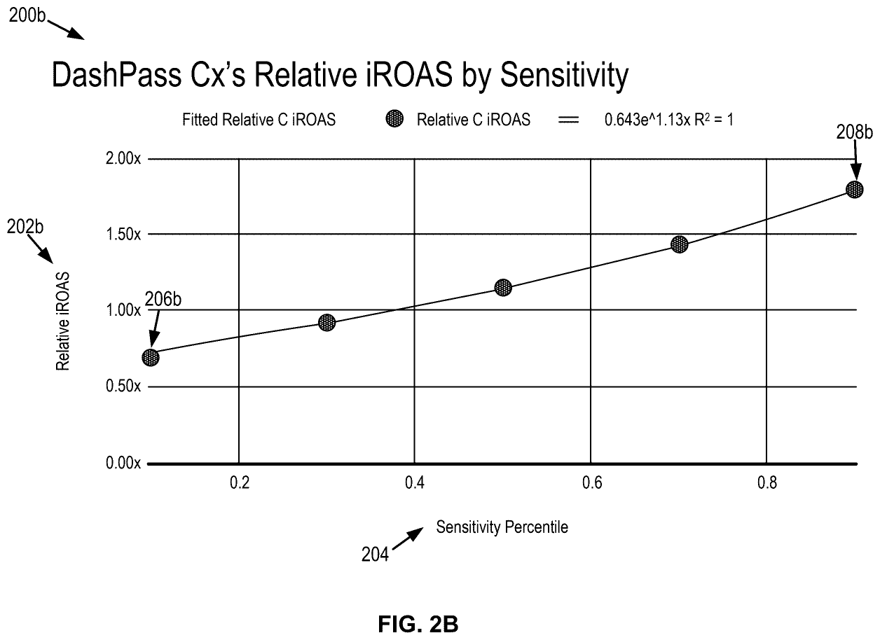

FIG. 2A shows a first plot 200a of aggregated user-specific ROAS values 202a against sensitivity percentiles 204a for unsubscribed users of the software application. The sensitivity percentiles 204a are user-specific ROAS values output by the trained machine learning model for each of the unsubscribed users in terms of percentiles. To provide the user-specific ROAS values in terms of percentiles, a number of ROAS values less than a given ROAS value can be divided by the total number of ROAS values and then the result can be multiplied by 100. Moreover, the aggregated user-specific ROAS values 202a may be averaged for each percentile. For example, as shown by point 206a in FIG. 2A, a lowest percentile of the unsubscribed users has an average ROAS value of about 0.8. Thus, the machine learning model predicted that the lowest percentile of unsubscribed users spends an average of $0.8 for each $1 received in promotion (e.g., in discount). In contrast, as shown by point 208a in FIG. 2A, a highest percentile of the unsubscribed users has an average ROAS value of about 1.25. Thus, the machine learning model predicted that the highest percentile of unsubscribed user spends an average of $1.25 for each $1 received in promotion (e.g., in discount). A higher percentile may be associated with users that are more sensitive to promotions (e.g., more likely to spend additional money on an order when provided with a promotion).

FIG. 2B shows a plot 200b of aggregated user-specific ROAS values 202b against sensitivity percentiles 204b for subscribed users of the software application. The sensitivity percentiles 204b are the user-specific ROAS values output by the trained machine learning model for each of the subscribed users in terms of percentiles. Moreover, the aggregated user-specific ROAS values 202b may be averaged for each percentile of the subscribed users. For example, as shown by point 206b in FIG. 2B, a lowest percentile of the subscribed users has an average ROAS value of about 0.7. Thus, the machine learning model predicted that the lowest percentile of subscribed users spends an average of $0.7 for each $1 received in promotion (e.g., in discount). In contrast, as shown by point 208b in FIG. 2B, a highest percentile of the unsubscribed users has an average ROAS value of about 1.8. Thus, the machine learning model predicted that the highest percentile of subscribed users spends an average of $1.80 for each dollar received in promotion (e.g., in discount).

### B. Modeling Incremental Interactions for Consumer-Provider Pairs

Similar to modeling incremental interactions (e.g., sales) for users, the data for the cohort of users of the software application may be obtained. The data may indicate, for each user, purchases made both with and without the promotions. The data may further indicate the resource provider associated with each purchase made by the user. As such, user-provider pairs may be generated for each user and each resource provider from which the user can place orders using the software application.

Moreover, a user-provider feature vector associated with each user-provider pair may be generated based on the data. Features included in the user-provider feature vector may include a number of orders placed with the provider over a time frame (e.g., a previous 7, 30, 60, 90, 150, 200, 250, 300, or 365 days or any number of days therebetween), a number of non-discounted orders placed by the user over a time frame, a number of days in which the user accessed the software application over a time frame, a numbers of days with orders over a time frame, a conversion rate (e.g., a ratio of the number of days with orders to the number of visits), an average discount per order per user over a time frame, a number of orders from dimension deliveries, no filter, over a time frame, an average subtotal for orders placed over a time frame, consumer tenure in days, a measure of how many orders the user placed per provider or per set of providers, a variance of post discount subtotal per user over a time frame, a percentage of non-discounted orders over a time frame, an indicator of whether a user is a subscriber to the software application, other features, or a combination thereof.

The user-provider feature vector for each user may then be input into a second machine learning model. The second machine learning model may be executed to determine a ROAS value for each user-provider pair. That is, the second machine learning model may output an estimated increase in spending by the user per dollar received by the user in promotions from the resource provider. The second machine learning model may include a light GVM model, another tree-based machine learning model, a neural network, a support vector machine, a logistic regression model, a linear regression model, other type of machine learning models, or a combination thereof.

In some cases, the second machine-learning model may be initially trained using a set of training data. For example, the data for the cohort of users of the software application may be split into a training dataset and a testing data set. The second machine-learning model may be trained using the training dataset that includes data for orders placed by a first subset of the users with and without promotions. The second machine learning model may be checked for accuracy using the testing data set and may then be deployed for use in determining ROAS values for user-provider pairs. The second machine-learning model may be periodically updated and re-trained based on new training data to keep the machine-learning model up to date and accurate.

Similar to the output of the machine learning model for incremental interactions (e.g., incremental sales) at the consumer level, an output of the second machine learning model may be normalized such that the average output by the machine learning model is 1. Consequently, the output of the machine learning model may be a predicted ROAS value that indicates, for each $1 discount received from a resource provider, how much a user is predicted to increase spending on an order from the resource provider.

After obtaining the ROAS values for each user-provider pair, the ROAS values may be sorted based on an order frequency associated with each user-provider pair (e.g., a number of orders placed by the user for that resource provider order a period of time, such as a previous 90 days). After sorting the user-provider pairs by order frequency, a simple regression model may be used to generate predicted ROAS values for each order frequency level. Order frequency levels may be ranges (e.g., 0-2 orders, 3-5 orders, 6-8 orders, and 8 or more orders) or values (e.g., 1, 2, 3, 4, 5, etc.).

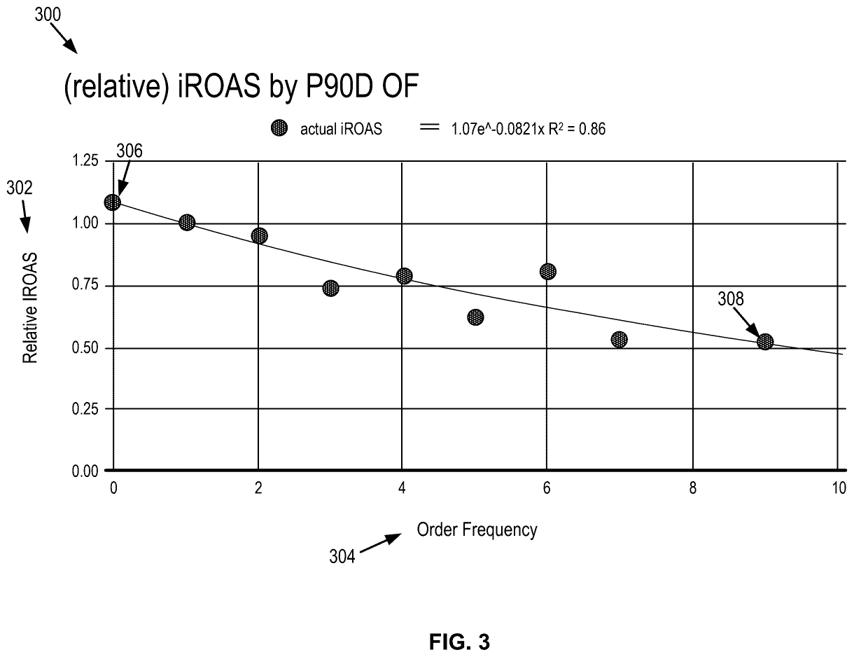

FIG. 3 shows a plot 300 of the predicted ROAS values 302 against order frequency levels 304. FIG. 3 shows that as order frequency increases, the predicted ROAS values decrease. Thus, FIG. 3 suggests that sensitivity to promotions may decrease as order frequency increases. For example, as shown by point 306, a predicted ROAS value for users who have ordered from any given resource provider 0 times in the previous 90 days is 1.07. In contrast, as shown by point 308, a predicted ROAS value for users who have ordered 8 or more times from any given resource provider is 0.55.

### C. Determining Consumer-Specific, Provider-Specific Incremental Interactions

To determine consumer-specific, provider-specific incremental interaction values (e.g., consumer-specific, provider-specific ROAS values), the user-specific ROAS values may be multiplied by the predicted ROAS value for a relevant order frequency. The equation for consumer-specific, provider-specific ROAS values is shown below (Equation 1). The values can be multiplied because of the normalization of the ROAS values output by the above machine learning models such that the ROAS values have an average of 1. Cosequently, when the ROAS values are multiplied, the overall average incrementality is not affected.

consumer-specific,provider-specific ROAS=f(Cx,Mx)=f₁(user-specific ROAS value)·f₂(predicted ROAS value for order frequency) Equation 1

In some examples, the consumer-specific, provider-specific ROAS value may be converted to an absolute consumer-specific, provider-specific ROAS value by multiplying consumer-specific, provider-specific ROAS value by an overall average ROAS value. In one example, an overall average ROAS value for a top 70% of resource providers is 0.98 while an overall average ROAS value for a bottom 30% of resource providers is 1.22. The ranking of resource providers to obtain the top 70% and bottom 30% may be based on overall order volume via the software application for each of the resource providers. A separate analysis of the resource providers may be performed to determine the overall average ROAS values.

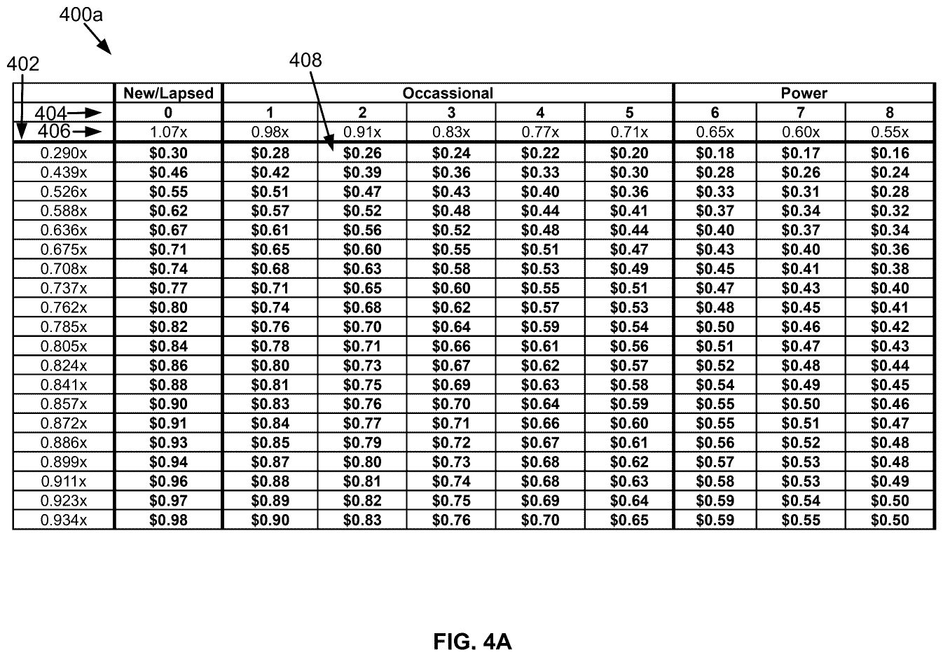

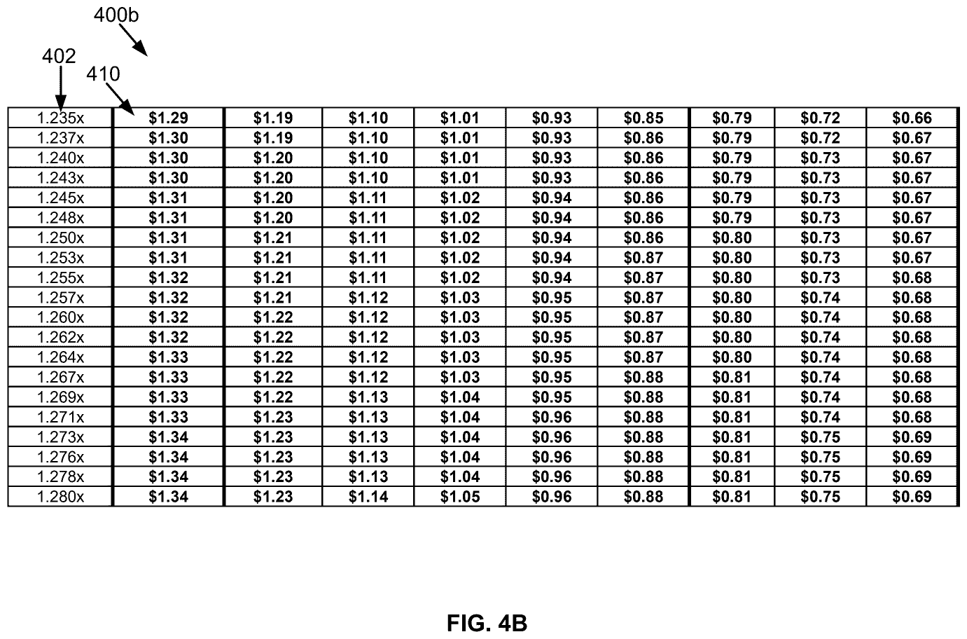

FIG. 4A shows first section 400a of a table of consumer-specific, provider-specific ROAS values for unsubscribed users of the software application. As shown, a first column 402 includes the user-specific ROAS values predicted by the machine learning model for a portion of the unsubscribed users. Additionally, a first row 404 includes order frequency levels and a second row 406 includes the predicted ROAS values for each order frequency level. The first section 400a then includes consumer-specific, provider-specific ROAS values generated by multiplying each user-specific ROAS value with each predicted ROAS value for each order frequency. For example, in block 408 of the table, a consumer-specific, provider-specific ROAS value is provided. The consumer-specific, provider-specific ROAS value in block 408 is $0.26 which is obtained by multiplying 0.91 by 0.29. Thus, for the user associated with block 408, it is predicted that any given resource provider from which the user has ordered from twice will obtain $0.26 per $1 spend on promotions provided to the user.

FIG. 4B shows a second section 400b of the table of consumer-specific, provider-specific ROAS values for unsubscribed users of the software application. The second section 400b also includes consumer-specific, provider-specific ROAS values generated by multiplying each user-specific ROAS value (as shown in the first column 402) with each predicted ROAS value for each order frequency (as shown in the second row 406 in FIG. 4A). For example, in block 410 of the table, a consumer-specific, provider-specific ROAS value is provided. The consumer-specific, provider-specific ROAS value in block 410 is $1.29, which is obtained by multiplying 1.235 by 1.07.

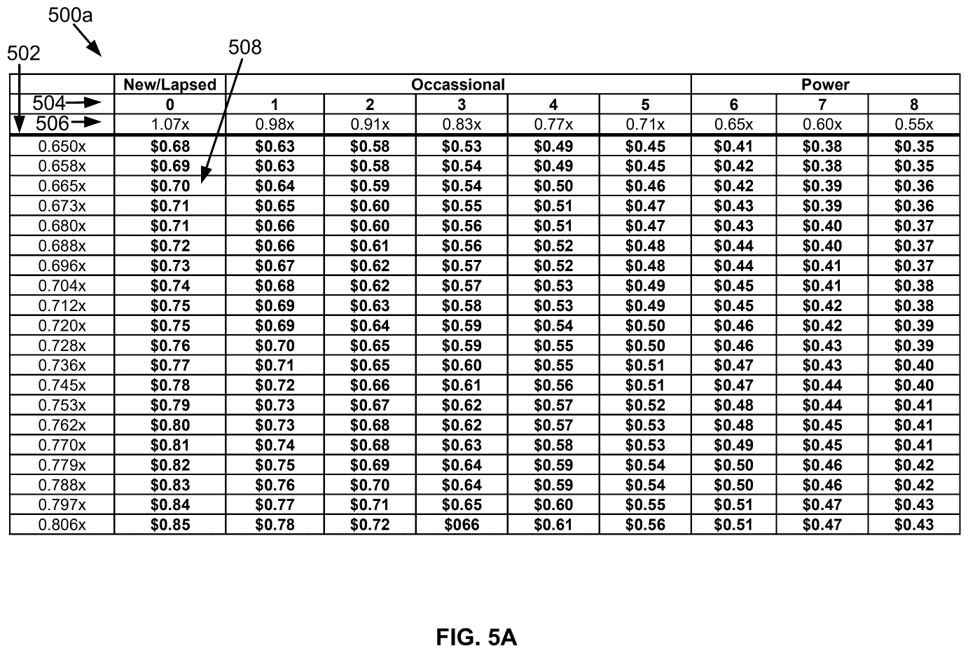

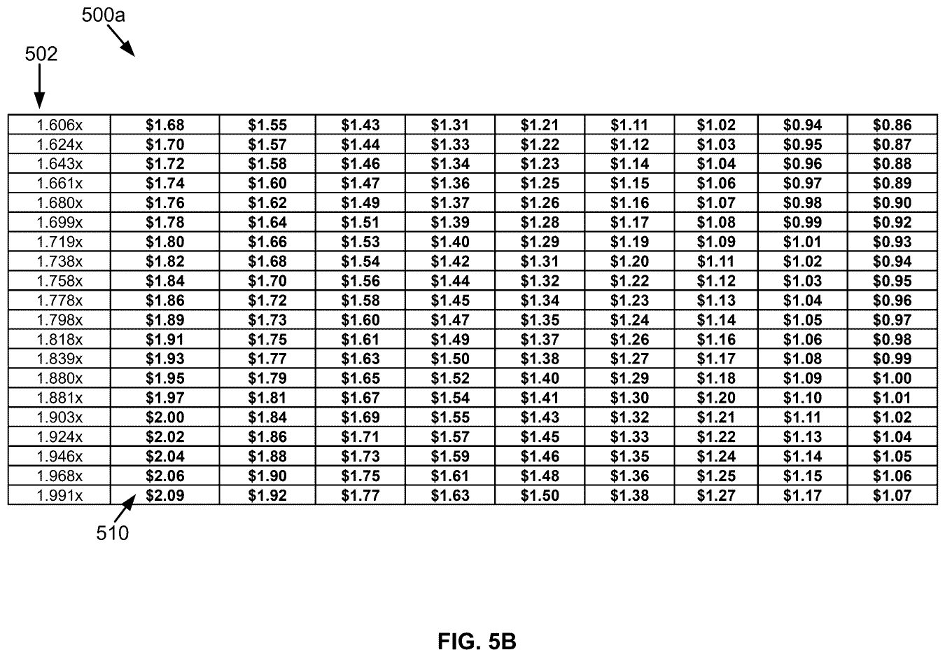

FIG. 5A shows first section 500a of a table of consumer-specific, provider-specific ROAS values for subscribed users of the software application. As shown, a first column 502 includes the user-specific ROAS values predicted by the machine learning model for a portion of the subscribed users. Additionally, a first row 504 includes order frequency levels and a second row 506 includes the predicted ROAS values for each order frequency level. The first section 500a then includes consumer-specific, provider-specific ROAS values generated by multiplying each user-specific ROAS value with each predicted ROAS value for each order frequency. For example, in block 508 of the table, a consumer-specific, provider-specific ROAS value is provided. The consumer-specific, provider-specific ROAS value in block 508 is $0.70 which is obtained by multiplying 0.665 by 1.07. A larger ROAS consumer-specific, provider-specific ROAS may be preferable to a smaller consumer-specific, provider-specific ROAS value as it indicates higher spending per dollar in promotion.

FIG. 5B shows a second section 500b of the table of consumer-specific, provider-specific ROAS values for subscribed users of the software application. The second section 500b also includes consumer-specific, provider-specific ROAS values generated by multiplying each user-specific ROAS value (as shown in the first column 502) with each predicted ROAS value for each order frequency (as shown in the second row 506 in FIG. 5A). For example, in block 510 of the table, a consumer-specific, provider-specific ROAS value is provided. The consumer-specific, provider-specific ROAS value in block 512 is $2.09 which is obtained by multiplying 1.991 by 1.07.

### D. Example Method for Modeling Incremental Interactions at a High Level of Granularity

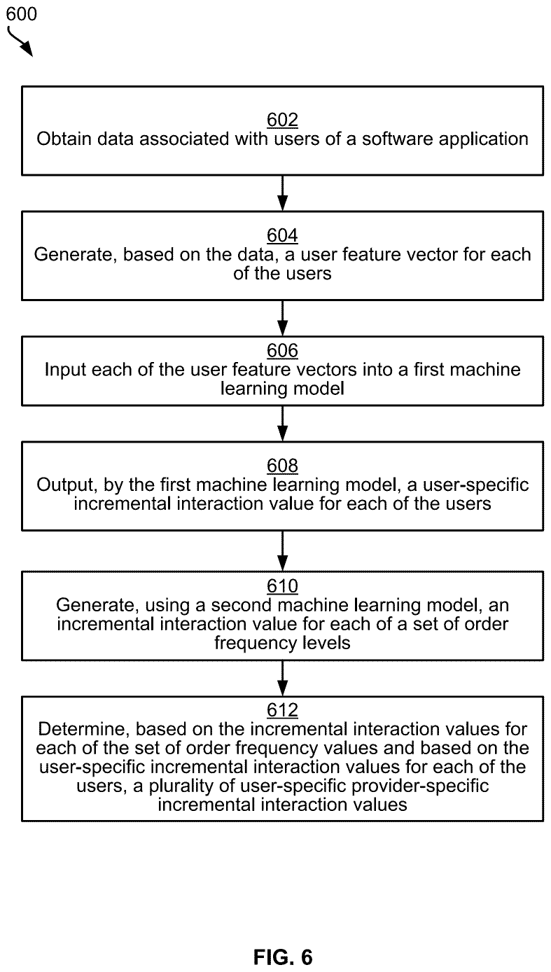

FIG. 6 is a flowchart illustrating a method 600 for modeling incremental interactions at a high level of granularity according to some embodiments of the present disclosure. FIG. 6 illustrates a comprehensive, multi-step method designed to model incremental interactions at a high level of granularity in the context of personalized promotion (campaign) generation using machine learning. The method broadly encompasses the acquisition and processing of extensive user and transactional data associated with a software application, the extraction of relevant features to represent individual users, and the application of advanced machine learning models to derive user-specific and provider-specific predictions of incremental values. By systematically leveraging these incremental interaction values, the method seeks to dynamically customize promotional offers at the user, provider, and user-provider pair levels, thereby optimizing the allocation and effectiveness of promotional spending. The approach further integrates techniques for decomposing complex modeling tasks, normalizing outputs for reliable comparison, and combining model results to enable robust, scalable, and efficient determination of targeted promotion strategies across large, heterogeneous user populations and resource providers.

At block 602, the method 600 may involve obtaining data associated with users of a software application (e.g., a delivery application). The data may be indicative of user interactions, such as food delivery or food pick up orders, placed by each of the users using the software application and may be indicative of resource providers, such as restaurants or stores, associated with each of the orders.

At block 604, the method 600 may involve generating, based on the data, a user feature vector for each of the users. Features included in the user feature vector may include a number of non-discounted orders over a time frame (e.g., a previous 365 days), a number of days in which the user accessed the software application over a time frame (e.g., a previous 365 days), a numbers of days with orders over a time frame (e.g., a previous 365 days), a conversion rate (e.g., a ratio of the number of days with orders to the number of days with access), an average discount per order per user over a time frame (e.g., a previous 365 days), a number of orders from dimension deliveries, no filter, over a time frame (e.g., a previous 365 days), an average subtotal for orders placed over a time frame (e.g., a previous 84 days), consumer tenure in days, a measure of how many orders a user places per resource provider or per set of resource providers, a variance of post-discount subtotal per user over a time frame (e.g., a previous 365 days), a percentage of non-discounted orders over a time frame (e.g., a previous 365 days), an indicator of whether a user is a subscriber to the software application, other features obtainable from the data, or a combination thereof.

At block 606, the method 600 may involve inputting each of the user feature vectors into a first machine learning model. The first machine-learning model may be a trained machine learning model. In one example, the first machine-learning model be trained using a training dataset that includes user feature vectors labeled with user-specific incremental interaction values.

At block 608, the method 600 may involve outputting, by the first machine learning model, a user-specific incremental interaction value for each of the users. In one example, in a first step, the first machine learning model may predict, based on the user feature vectors, an amount each user spends on orders placed with the software application without a promotion and an amount each user spends on orders placed with the software application with a promotion. In doing so, the machine learning model may generate a delta representative of a difference between the amount a user orders without a promotion and with a promotion. Then, in a second step, the first machine learning model may generate and output the user-specific incremental interaction value for each of the users. The user-specific incremental interaction values may each be an estimated increase in spending by a user per dollar received by the user in promotions.

At block 610, the method 600 may involve generating, using a second machine learning model, an incremental interaction value for each of a set of order frequency levels. In an example, based on the data, user-provider pairs may be generated for each user and each resource provider from which the user can place orders using the software application. Then, user-provider feature vectors may be generated and input into a second machine learning model. The second machine learning model may be executed to determine an incremental interaction value for each user-provider pair. That is, the second machine learning model may output an estimated increase in spending by each user per dollar received by the user in promotions from each resource provider.

After obtaining the incremental interaction values for each user-provider pair, the incremental interaction values may be sorted based on an order frequency associated with each user-provider pair. The order frequency may be a number of orders placed by the user for that resource provider order a period of time, such as a previous 90 days. After sorting the user-provider pairs by order frequency, a simple regression model may be used to generate predicted, average incremental interaction values for each order frequency level. Order frequency levels may be ranges (e.g., 0-2 orders, 3-5 orders, 6-8 orders, and 8 or more orders) or values (e.g., 1, 2, 3, 4, 5, etc.).

At block 612, the method 600 may involve determining, based on the incremental interaction values for each of the set of order frequency values and based on the user-specific incremental interaction values for each of the users, a plurality of user-specific provider-specific incremental interaction values. For example, to determine user-specific, provider-specific incremental interaction values each of the user-specific incremental interaction values may be multiplied by the predicted incremental interaction value for each order frequency level.

### III. Optimization of Custom Promotion

An optimization function may be used to generate optimized, custom promotions. In one example, the purpose of the optimization function for a custom promotion may be to determine an optimal discount amount. For example, how much money to provide customers with (x) and how much to require the customer to spend (y) to receive (x) may be determined as well as whether to offer the discount at all (z). The optimization function may be used to determine x, y, and z for all users for a given resource provider in order to maximize a weighted sum of net sales for the resource provider.

### A. Unconstrained Optimization

The optimization function used to generate optimal, custom promotions may include gᵢ, rᵢ, and τᵢ. Equations for gᵢ, rᵢ, and τᵢ are below (Equations 2, 3, and 4). As shown in the equations, g₁ and rᵢ are determined by multiplying G and R respectively by θ(i). Moreover, as shown in equation 4, τᵢ is equal to F. G, R, F, and θ(i) are defined in Table 1 below.

gᵢ=G(xᵢ,yᵢ,Mx)θ(i) Equation 2

rᵢ=R(xᵢ,yⁱ,Mx)θ(i) Equation 3

τᵢ=F(xᵢ,yᵢ,Mx) Equation 4

TABLE 1
Definitions for G, R, F, and θ(i)

| Variable | Assumption |
|---|---|
| θ(i) | The relative sensitivity of cohort i estimated |
| | from user-specific, provider-specific ROAS values |
| G(xᵢ, yᵢ, Mx) | The average order rate lift as a function of |
| | X, Y, and resource provider subtotal |
| R(xᵢ, yᵢ, Mx) | The average order volume (AOV) lift as a |
| | function of X, Y, and resource provider subtotal |
| F(xᵢ, yᵢ, Mx) | The average unit promo costs to AOV ratio as a |
| | function of X, Y, and resource provider subtotal |

Additionally, Equation 5 includes the optimization function. There may be no budget constraint on the optimization function (α=∞ (infinite budget)), and therefore the optimization function can be decomposed into an independent optimization for each cohort i (e.g., each user-provider pair.

$$∀ i , {max}_{( {x}_{i} , {y}_{i} , {z}_{i} )} {z}_{i} [ ( 1 + λ ) ( {g}_{i} + {r}_{i} + {g}_{i} {r}_{i} ) - ( 1 + {g}_{i} ) {τ}_{i} ] ≡ {max}_{( {x}_{i} , {y}_{i} , {z}_{i} )} {z}_{i} {V}_{i} ( {x}_{i} , {y}_{i} ) \qquad Equation 5$$

In some examples, the optimization function shown in equation 5 can be solved by grid-search. As a result, it is possible to enumerate through all possible combinations of (xᵢ, yᵢ) to find (xᵢ*, yᵢ*) that maximizes Vᵢ. Denote the value at optimal as Vᵢ*. If Vᵢ*>0, then zᵢ=1; else, zᵢ=0. If zᵢ=1, the optimal promotion associated with the provider and as indicated by (xᵢ*, yᵢ*) may be provided to a user via the software application. Otherwise, if zᵢ=0, the user may not receive a promotion.

### B. Constrained Optimization Based on Promotion Budget

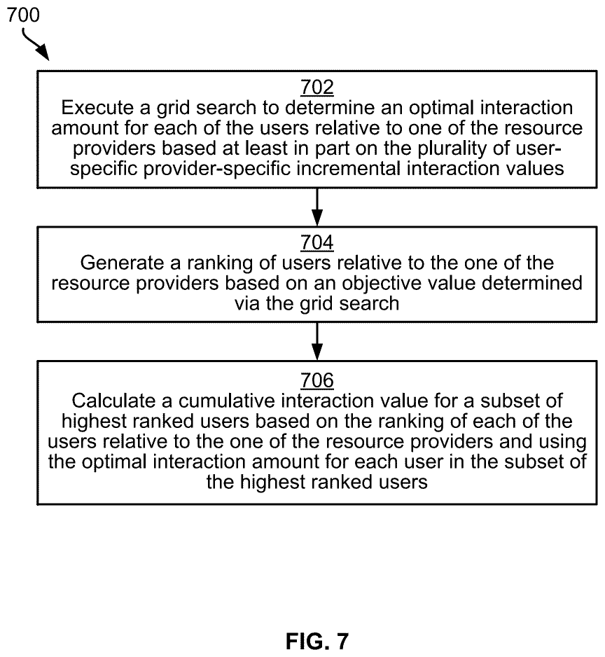

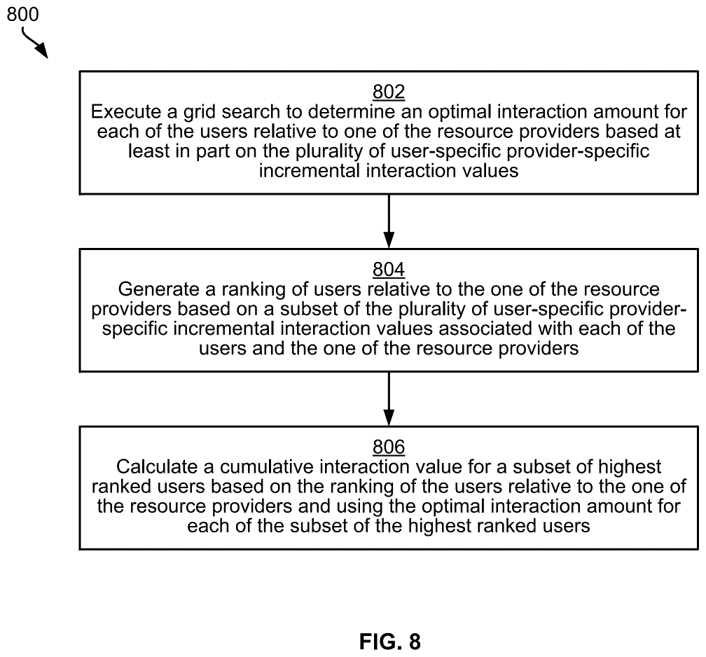

In some examples, there may be constraints imposed on the optimization function. For example, a budget constraint may specify that promotion costs (the sum of x) are to be less than or equal to a percentage of sales (a percentage of the sum of y). Example methods for solving the optimization function when a constraint is imposed are described below with respect to FIGS. 7-8.

### 1. Example Method for Constrained Optimization Using Objective Function

FIG. 7 is a flowchart illustrating a method 700 for constrained optimization using an objective function according to some embodiments of the present disclosure. The method 700 addresses the challenge of optimizing customized promotional interactions while adhering to constraints. The method 700 may be structured to achieve automated determination of optimal promotion parameters for individual users relative to specific resource providers by leveraging user-specific and provider-specific incremental interaction values derived from machine learning models. To do so, the method 700 encompasses the execution of an optimization process, such as a grid search, across possible promotion configurations, ranking users according to objective values that reflect predicted promotional efficacy, and systematically selecting a subset of users for whom promotions are to be allocated within a defined constraint. By integrating these steps, the method enables targeted allocation of promotional resources, ensuring that the most effective and efficient promotions are delivered to users in a way that maximizes return on advertising spend while respecting budgetary or operational limitations.

At block 702, the method 700 may involve executing a grid search to determine an optimal interaction amount for each of the users relative to one of the resource providers based at least in part on the plurality of user-specific provider-specific incremental interaction values. In doing so, the unconstrained optimization can be solved as described above. For example, as described above, the optimization function shown in equation 5 can be solved by grid-search. As a result, it is possible to enumerate through possible combinations of (xᵢ, yᵢ) to find (xᵢ*, yᵢ*) that maximizes Vᵢ. In particular, (xᵢ, yᵢ,*) may be found for each of the users with respect to the resource provider. (xᵢ*, yᵢ*) may represent the optimal interaction amount for each user in which xᵢ*is the amount provided to the user by the resource provider (e.g., is the promotional spend) and yᵢ* is a minimum amount the user is to spend to receive xᵢ*.

At block 704, the method 700 may involve generating a ranking of each of the users relative to the one of the resource providers based on an objective value determined via the grid search. That is, during the grid search, an optimal interaction amount ((xᵢ*, yᵢ*)) is found for each of the users with respect to the resource provider. As a result, an objective value

$$( e . g . , {max}_{( {x}_{i} , {y}_{i} , {z}_{i} )} {z}_{i} {V}_{i} ( {x}_{i} , {y}_{i} ) )$$

may be calculated for each user relative to the resource provider. Consequently, the users can be ranked by the objective values. Users associated with higher objective values may be ranked higher.

At block 706, the method 700 may involve calculating a cumulative interaction value for a subset of highest ranked users based on the ranking of each of the users relative to the one of the resource providers and using the optimal interaction amount for each user in the subset of the highest ranked users. The cumulative interaction value may be a total amount of promotional spending on promotions provided to the subset of highest ranked users. The cumulative interaction value may be less than or equal to a constraint. For example, the yᵢ* from each optimal interaction amount may be added starting from a highest ranked user and moving down the ranking until the cumulative interaction value (e.g., the cumulative yᵢ*) is equal to or nearly equal to the constraint. Once the cumulative interaction value is equal to or nearly equal to the constraint, the optimal interaction amounts may be provided, via the software application, to the users associated with the cumulative interaction value within the constraint.

### 2. Example Method for Constrained Optimization Using Incremental Interactions

FIG. 8 is a flowchart illustrating a method 800 for constrained optimization using incremental interactions according to some embodiments of the present disclosure. The method 800 is broadly directed to the constrained optimization of personalized promotional offers using user-specific, provider-specific incremental interaction values within a resource provider's budgetary or operational limits. The method 800 may be designed to systematically rank and select users for customized promotions based on their predicted responsiveness and the incremental value they can deliver, while ensuring that cumulative promotional spending does not exceed pre-established constraints. Through a combination of grid search optimization and dynamic user ranking, this approach enables the allocation of promotional resources in a manner that maximizes overall effectiveness and return on advertising spend (ROAS), while maintaining strict compliance with constraints of resource providers. The method's structure supports both fine-grained personalization and real-time adaptability, thereby addressing the need for efficient, scalable, and budget-conscious promotional campaign management in data-rich digital marketplaces and software applications.

At block 802, the method 800 may involve executing a grid search to determine an optimal interaction amount for each of the users relative to one of the resource providers based at least in part on the plurality of user-specific provider-specific incremental interaction values. Block 802 may be performed in the same or a similar manner as described above with respect to block 702.

At block 804, the method 800 may involve generating a ranking of users relative to the one of the resource providers based on a subset of the plurality of user-specific provider-specific incremental interaction values associated with each of the users and the one of the resource providers. The subset of user-specific provider-specific incremental interaction values may be from the user-specific provider-specific incremental interaction values described above with respect to FIG. 6. The subset of user-specific provider-specific incremental interaction values may be ranked from highest value to lowest value. As a result, the users can be sorted by their relative sensitivity to promotions from the resource provider from high to low.

At block 804, the method 800 may involve calculating a cumulative interaction value for a subset of highest ranked users based on the ranking of the users relative to the one of the resource providers and using the optimal interaction amount for each of the subset of the highest ranked users. The cumulative interaction value may be less than or equal to a constraint. In one example, the yᵢ* from each optimal interaction amount may be added starting from a highest ranked user and moving down the ranking until the cumulative interaction value (e.g., the cumulative yᵢ*) is equal to or nearly equal to the constraint.

Alternatively, in some examples, the determining of the optimal interaction amount may occur after the ranking of the users based on the subset of user-specific provider-specific incremental interaction values may. Therefore, in some examples, the optimal interaction amount may be calculated for a segment (e.g., a top 10%) of the users and then the cumulative interaction value (e.g., the cumulative yᵢ*) can be determined for the segment. If the cumulative interaction value exceeds the constraint, the calculation may stop. Otherwise, the optimal interaction amount for another segment (e.g., the next 10%) of the users can be calculated and added to the cumulative interaction value. Once the cumulative interaction value is equal to or nearly equal to the constraint, the optimal interaction amounts may be provided, via the software application, to the users associated with the cumulative interaction value within the constraint.

### IV. Dynamic Convergence of Cumulative Promotion

As described above, optimal, custom promotions can be determined for users and provider-user pairs, and such optimal custom promotions can be used to dynamically allocate the custom promotions. That is, for example, a cumulative promotion spending can be determined for a subset of highly ranked users, where the users may be ranked based on user-specific, provider-specific ROAS values. Then, the subset of highly ranked users can receive the optimal, custom promotions. The cumulative promotional spending may be constrained to an optimized value or a bugdetary constraint and may be adjusted according to a model with a feedback control mechanism. Which or how many users receive promotions may also be controlled based on the the model with the feedback control mechanism.

Accordingly, the model with the feedback control mechanism can serve as an adaptive control system for monitoring spend-to-sales (STS) ratios for resource providers, comparing the STS ratios to predefined targets, and dynamically updating eligibility parameters to minimize discrepancies. The eligibility parameters may then be ingested by the described machine learning models as features used in generating optimal promotions, user rankings, cumulative promotional spending, etc. By periodically feeding observed promotional outcomes (e.g., sales associated with promotions) back into the process of generating optimal promotions, user rankings, cumulative promotional spending, etc., via the monitoring and comparison of STS ratios, the model with the feedback mechanism can enables more precise and stable regulation of promotional spending. Additionally, the model with the feedback mechanism can ensure that resource providers achieve business objectives, such as maximizing profit or accelerating growth, while maintaining compliance with constraints, such as budgetary constraints.

The model with the feedback control mechanism may operate at either or both of the global and individual provider levels, with the model's eligibility parameters being tuned to the appropriate granularity for each context. Collectively, the feedback mechanism can enable the system to provide stable, automated, and provider-specific promotional spend regulation, thereby addressing evolving user behavior and market dynamics and overcoming the technical challenges inherent to the traditional, static approaches.

### A. Problems with Lack of Feedback

A lack of a closed-loop feedback system in the generation of optimized, custom promotion spending can prevent accurate achievement of target Spend-to-Sales (STS) ratios at both the digital marketplace and provider levels. For instance, when machine learning models use each provider's target STS ratio as a feature but rely on fixed model parameters, set through one-time offline simulations and analysis, there is no continuous adjustment based on real-time or recent performance data. Such fixed parameters may relate to an intensity of promotional discounts, a breadth of user eligibility for promotions, or a combination thereof. For example, a spend x get y (SXGY) alpha shrink factor may be a first eligibility parameter that regulates a portion of a provider's overall promotional budget that is allocated specifically to SXGY promotions. Conversely, a buy one get one (BOGO sensitivity threshold) may be a second eligibility parameter that provides a sensitivity score that reflects a predicted likelihood that a user will respond incrementally to a BOGO offer.

However, maintaining the eligibility parameters, such as SXGY alpha shrink factor and BOGO sensitivity threshold at static, fixed values can lead to two main problems. First, it can lead to aggregate bias: a persistent gap between the marketplace-level target STS ratios and actual STS ratios. This bias may arise because offline simulations and fixed values cannot accurately and comprehensively reflect real-world performance, and this gap can widen if eligibility parameters are not regularly updated. Second, the use of fixed parameters fails to accommodate provider-specific differences. For example, while a fixed set of parameters may align an average provider's STS ratio with a target STS ratio, individual providers can diverge significantly. Thus, eligibility parameter values may need to adapt to the variance observed across different providers to align actual and target STS ratios of the different providers.

The embodiments described herein address these challenges by providing a model with an automated feedback mechanism that dynamically adjusts eligibility parameters based on actual STS ratios observed over time. This closed-loop feedback control can operate at either the global or provider level. By continuously adapting eligibility parameters to real-world promotional performance, the model with the feedback control mechanism can minimize gaps between target and actual STS ratios, safely increase STS ratio targets without exceeding constraints such as budget limits, and reduce the manual effort required for ongoing monitoring and recalibration of eligibility parameters.

### B. Example Use of STS Ratio in ML Model with Feedback

In one example, the model with the feedback control mechanism is a machine learning (ML) model governs the allocation of promotional spending for different types of promotions, such as “Spend X Get Y” (SXGY) and “Buy One Get One” (BOGO) campaigns. To do so, the machine learning model can include two eligibility parameters for controlling a spend rate for SXGY promotions and for BOGO promotions, respectively. The two parameters may be the SYGX alpha shrink factor and the BOGO sensitivity threshold. The feedback control mechanism may operate as a negative feedback loop that periodically, such as daily, adjusts one or both of the eligibility parameters in a direction that minimizes the difference between each provider's or digital marketplace's actual spend-to-sales (STS) ratio and the corresponding target STS ratio.

The adjustment process can follow a control process in which a proportional-integral-derivative (PID) controller can be used to update the eligibility parameters in a manner proportional to a current error. The current error may be a difference between a target STS ratio and an actual observed STS ratio over a recent time period, such as the last seven days. The mathematical update for the SYGX alpha shrink factor can be expressed with Equation 6 while the mathematical update for the BOGO sensitivity threshold can be expressed with Equation 7. Definitions for sts_ratio_{target}, sts_ratioₜ,

$${k}_{p} = \frac{f}{G} ,$$

f, and G in Equations 6 and 7 is shown below in Table 2.

$${param}_{t + 1}^{SXGY} ← {param}_{t}^{SXGY} + clip ( \frac{f}{{G}^{SXGY}} ( {sts\_ratio}_{target}^{SXGY} - {sts\_ratio}_{t}^{SXGY} ) ) \qquad Equation 6$$

$${param}_{t + 1}^{BOGO} ← {param}_{t}^{BOGO} + clip ( \frac{f}{{G}^{BOGO}} ( {sts\_ratio}_{target}^{BOGO} - {sts\_ratio}_{t}^{BOGO} ) ) \qquad Equation 7$$

TABLE 2
$Definitions for {sts\_ratio}_{target} , {sts\_ratio}_{t} , {k}_{p} = \frac{f}{g} , f and G$

| Variable | Assumption |
|---|---|
| sts_ratio_{target} | The target STS ratios used for calibration of the model with |
| | the feedback control mechanism. Initial STS ration targets |
| | may be predetermined amount overall and different |
| | promotions may add to the target STS ratio. |
| sts_ratioₜ | An actual observed STS ration over a period of time, such |
| | as a previous 3, 7, 10, 14, 30, 60, or 90 days. |
| ${k}_{p} = \frac{f}{g}$ | A proportional coefficient, representing how much the eligibility parameter should be adjusted for every one-unit error in the STS ratio. |
| ƒ | A periodic, such as daily, correction rate, representing a |
| | percentage of errors corrected each period, such as each day. |
| | For example, if f = 0.15, then 15% of the remaining error is |
| | corrected daily. In this example, it would take roughly 4 |
| | days for the error to halve, since (1 - 0.15)⁴ ≈ 0.5. The |
| | value of f can be chosen to balance convergence speed |
| | with stability. |
| G | A sensitivity coefficient, measuring how much the observed |
| | STS ratio changes for a one-unit change in the eligibility |
| | parameter. |
| | $Mathematically , G = \frac{Δ sts\_ratio}{Δ param} .$ |

This feedback process as well as Equations 6 and 7 can be applied at either the global (marketplace-wide) level or at the individual resource provider level. At the global-level, the STS ratios and eligibility parameter updates may be computed across the resource providers of a digital marketplace, with the resulting eligibility parameter values being shared across the resource providers. At the individual provider-level, the STS ratios and eligibility parameter updates may be computed individually for each resource provider, allowing for more granular and adaptive control of the STS ratios and eligibility parameters. The values of f and G may be tuned separately for the marketplace level and the individual provider level, since data from individual resource providers is often more volatile than aggregated data across resource providers.

The sensitivity coefficient, G, may be determined empirically for each eligibility parameter associated with each type of promotion to quantify how changes in the eligibility parameter affects associated STS ratios. For SXGY promotions, G may reflect a linear and positive relationship between the SXGY alpha shrink factor and the resulting STS ratio. Thus, increasing the SXGY alpha shrink factor may generally increase the SXGY STS ratio. For BOGO promotions, G may reflect a non-linear and negative relationship between the BOGO sensitivity threshold and the resulting STS ratio. Thus, raising the BOGO sensitivity threshold may generally reduce BOGO STS ratio, since fewer users will be deemed sensitive enough to receive BOGO offers.

To accurately capture the above relationships, a segmented linear approximation can be employed to determine G. For example, this approach may involve dividing value ranges of the eligibility parameters into multiple segments and fitting a separate linear relationship within each segment. By doing so, the ML model can effectively approximate non-linear or piecewise-linear effects that may occur in practice, thereby facilitating more precise and stable eligibility parameter adjustments. Additionally, the values of G for each segment can be empirically derived based on historical or experimental data, and may be further adjusted to account for differences between experimental settings and production (go-to-market (GTM)) environments. As a result, G may assume different values depending on the specific range of the eligibility parameter. Additionally, to ensure model stability and prevent erratic updates, updated eligibility parameter values or STS ratios may be clipped within predefined bounds.

The correction rate, f, may determine how quickly the feedback control mechanism updates the eligibility parameters in response to deviations between the target and actual STS ratios. Initially, a base correction rate (f_{base}) may be set to a predetermined value that can be applied across the eligibility parameters and promotion types. However, to ensure responsive yet stable adjustments, the effective correction rate can be modulated by a signal-to-noise ratio (SNR). The SNR may be a measure of a proportion of observed deviation that is attributable to true signal rather than random noise, and is described in further detail below. Equation 8 shows an example of a formula for calculating f.

f=f_{base}*\sqrt{SNR} Equation 8

Th adaptive adjustment of f may help to prevent the system from overreacting to short-term fluctuations or measurement noise, which could otherwise lead to instability or oscillatory behavior in parameter updates. Because observed STS ratios, such as those computed over a rolling seven-day window, inherently fluctuate due to both digital marketplace dynamics and random noise, the SNR provides a quantitative basis for distinguishing between meaningful deviations and background variability. When the SNR is low, indicating that most observed deviation is noise, f can be automatically reduced, resulting in smaller parameter updates. Conversely, when the SNR is high, the f can be increased to permit larger parameter adjustments. Thus, using SNR in the calculation of f can result in smoother and more stable parameter updates.

Moreover, the value of f may be further tailored based on the magnitude of the error (e.g., a difference between observed and target STS values) and order volumes. For example, a relatively large error can be associated with a relatively strong signal while a relatively large order volume can be associated with relatively low noise. Thus, the relatively large error, the relatively large order volume, or the combination thereof can be associated with a relatively high correction rate (f) and shorter half-life (e.g., time for reducing the error by half). This dynamic scaling of f ensures that the feedback control mechanism can respond quickly when there is clear evidence of deviation, yet remains stable and conservative when the underlying data is noisy or ambiguous.

As described above, Signal-to-Noise Ratio (SNR) may be used to adaptively control the correction rate in the feedback control mechanism that regulates Spend-to-Sales (STS) ratios for promotional campaigns. SNR may be calculated separately for each promotion type and at each periodic update, using the formula provided by Equation 9. In Equation 9, e_(t,i) represents the squared error (difference) between a target STS ratio and an actual observed STS ratio for promotion (i) at time (t) and σ_i\hat{ }2 is the estimated noise variance for that promotion (i). The formula can effectively quantify how much of the observed deviation from the target STS value is attributable to true signal (actual error) versus random noise (random variations in order volume or promotion use).

$${SNR}_{t , i} = \frac{{e}_{t , i}^{2}}{{e}_{t , i}^{2} + {σ}_{i}^{2}} \qquad Equation 9$$

The global-level STS ratios can be associated with lower noise and lower volatility compared to provider-level STS ratios. Additionally, among individual resource providers, those with a larger order volume can be associated with lower noise and lower volatility. Thus, the global level and the resource providers with higher order volumes may be associated with a relatively greater SNR, thereby enabling quicker adjustments in the corresponding eligibility parameters.

To estimate the noise variance, the volatility of a time series of STS ratios for each provider can be analyzed. Since traditional promotional campaign models use fixed parameters, any observed variation over time in a provider's STS ratio may be presumed to reflect marketplace noise rather than deliberate changes. Thus, by tracking the volatility over historical STS ratios for a provider, an average noise variance for the provider can be estimated and used the SNR calculation.

Additionally, given the wide variability in stability in STS ratio across resource providers, the model can allow for different SNR values to be used for different providers. This, in turn, can ensure that the feedback control mechanism is appropriately cautious for providers with highly volatile STS ratios, such as by making smaller parameter adjustments to avoid overreacting to noise, while also enabling more aggressive corrections for providers with more stable STS ratios. Moreover, for merchants with low order or sales volumes, default values for the parameters can be used.

### C. Overview of Example Use of STS Ratio in ML Model with Feedback

In some implementations, a system comprising the ML model with the feedback control mechanism for regulating provider-level STS ratios can be designed to automatically adjust promotional spend parameters, such as SXGY alpha shrink factor and BOGO sensitivity threshold, in response to observed deviations from a target STS ratio. The ML model with the feedback control mechanism can be configured to operate at either the aggregate marketplace level, per individual resource provider within the market place, or for sets of resource providers within the marketplace. In this way, the ML model can enable both centralized and granular control over promotional spending. The STS ratio can be defined as the total promotional spend for a given entity (e.g., provider, set of providers, or all providers within a digital marketplace) divided by the entity's total sales. Entity's may specify their desired target STS ratio based on profitability goals or risk tolerance.

The feedback control mechanism can include a daily loop that measures the actual STS ratio for each entity, compares the actual STS ration to the target STS ratio, and adjusts a hyperparameter governing the eligibility or intensity of promotions accordingly. The hyperparameter may control a percentage of users that are eligible to receive a promotion or a scale of the promotional offer. For example, if the observed STS ratio exceeds the target STS ratio, the system can decrease the hyperparameter, to thereby reducing promotional exposure and spend. Conversely, if the STS ratio is below the target STS ratio, the system can increase the parameter to stimulate more promotional activity. This adjustment mechanism can enable providers to “set and forget” the STS targets, relying on the system to automatically maintain the STS ratio within desired bounds without manual intervention.

In some embodiments, the system can support multiple types of promotions, such as spend X get Y (SXGY) and buy one get one (BOGO), each with its own eligibility parameter (e.g., SXGY alpha shrink factor and BOGO sensitivity threshold) and target STS ratio. The feedback control mechanism can operate independently for each promotion type, maintaining separate STS targets and adjustment logic. The eligibility parameter update for each promotion type can be calculated as a function of the difference between the target and actual STS ratios, scaled by a sensitivity coefficient (G) and a correction rate (F). The sensitivity coefficient G may quantify how much the STS ratio changes for a one-unit change in the eligibility parameter, and may be estimated from historical data by analyzing the relationship between parameter values and observed promotional spend outcomes.

The correction rate F can be dynamically adjusted based on signal-to-noise ratio (SNR) of an entity's STS ratio metrics. For stores with stable, high-volume sales, the SNR may be relatively higher than stores with instable, lower-volume sales, allowing for faster corrections of STS ratios for the entities with stable, high-volume sales. Conversely, for the entities with lower-volume sales and greater daily fluctuations, the SNR may be lower, prompting the system to apply smaller adjustments to avoid instability or overreaction to noise (e.g., random fluctuations in sales and STS ratios). The SNR can be calculated as the squared error between target and actual STS ratios divided by the sum of squared error and estimated noise variance, as shown in Equation 9. The noise variance may be estimated from the standard deviation of STS ratios over time for entities of similar sales volumes. This adaptive correction mechanism can ensure stable convergence toward the target STS ratio across a diverse entity base, accommodating both large and small entity's.

The system can implement a clipping function to limit a maximum periodic, such as daily, change in the eligibility parameters. This, in turn, can prevent abrupt shifts in the eligibility parameters that might destabilize promotional delivery or disrupt resource provider operations. The eligibility parameter for each time period can be updated by adding the clipped adjustment value to the previous value of the parameter, ensuring smooth transitions and predictable behavior. Entity's may configure the STS ratio targets for each promotion type, and the system may handle the details of daily parameter updates, ranking, and eligibility determination.

In some implementations, the eligibility parameters, such as SXGY alpha shrink factor, BOGO sensitivity threshold, or the combination thereof, serve as inputs to a machine learning

(ML) model that predicts which users are most likely to respond to a promotion. The ML model can output a probability score for each user and promotion type, and user's exceeding a threshold may receive the promotion. This approach can allow for individualized targeting, optimizing promotional spend by focusing on users with higher expected incremental returns. The model may incorporate features such as customer purchase history, order frequency, and response to prior promotions, enabling nuanced allocation of promotional budgets.

The feedback control mechanism can further be integrated with a real-time data pipeline that ingests daily sales and promotional spend data for each provider associated with a software application or digital marketplace, processes the data, and stores updated eligibility parameters in a feature store accessible by the ML model for predicting users that are most likely to respond to a promotion. The data pipeline can cluster provider's by seven-day sales volume to facilitate noise estimation and parameter tuning. The feature store can act as persistent storage for eligibility parameters, STS ratio targets, and observed values, supporting both batch and real-time inference in the promotional delivery system.

In some embodiments, the system supports guardrails such as absolute upper bounds on periodic, such as daily or weekly, STS ratios, enforced through a hard cap mechanism that disables promotional delivery when the STS ratio exceeds a threshold. Thus, the feedback control mechanism can focus on long-term average STS ratio regulation, while the hard cap provides day-to-day or weekly protection against promotional overspending. The feedback control mechanism and the hard cap mechanism can operate in parallel, with the hard cap mechanism acting as a safety net and the feedback control mechanism maintaining ongoing compliance with entity objectives.

The relationship between the eligibility parameters and promotional spending can exhibit non-linearities and interdependencies, especially when multiple promotion types are served in parallel. For example, increasing the eligibility for one promotion may reduce redemption rates for another due to mix shift effects. In practice, the system may simplify the parameter adjustment logic by assuming independence between promotion types, but can be extended to model cross-effects if needed for greater accuracy.

Historical data analysis can be used for calibrating the sensitivity coefficient G and understanding the causal relationship between eligibility parameter changes and STS ratio outcomes. The system can track eligibility parameter values, eligibility ratios, and promotional spend for each provider and promotion type, fitting regression models or surface plots to estimate G. This calibration process can be repeated as new data becomes available, ensuring ongoing accuracy and responsiveness of the system.

The feedback control mechanism can be flexible and scalable, and therefore capable of operating at both the global marketplace level and the individual provider level. Providers can benefit from automated, adaptive regulation of promotional investments, reducing manual workload and improving compliance with budgetary constraints. The daily or otherwise periodic loop, dynamic correction rate, and parameter clipping can collectively provide robust, stable performance under varying market conditions and customer behaviors.

In some implementations, the system can expose API endpoints or user interfaces for providers to set STS ratio targets, review historical performance, and adjust configuration parameters. The integration with machine learning models and real-time data pipelines enables seamless, automated management of promotional spend, supporting both profitability and growth objectives.

Overall, the feedback control technique described herein combines statistical modeling, adaptive parameter adjustment, and real-time data processing to deliver efficient, scalable, and merchant-friendly regulation of promotional spend in online marketplaces.

### V. Managing Promotion Pages Served to Users

Prior systems generally do not enforce absolute upper bounds on promotional spending at the individual provider level. As a result, promotional costs may escalate beyond acceptable limits due to demand spikes, model miscalibration, or delayed corrective action, exposing providers to financial risk and reducing predictability of spend outcomes.

An additional technical challenge is that implementing real-time hard constraints requires enforcing absolute spending limits while minimizing abrupt changes to promotional delivery. An ideal system balances strict constraint compliance with smooth transitions to avoid adverse impacts on provider experience and ongoing promotional effectiveness.

By enforcing absolute promotional spend limits at the provider level, embodiments can provide predictable and bounded promotional exposure. This can ensure a predefined maximum spend ratio is not exceed at the provider level, reducing financial risk and supporting broader adoption of automated promotional allocation systems.

The system can be designed to enforce strict, real-time limits (hard constraints) on an amount of promotional spending that any given provider can accrue in a day. This enforcement may be conducted independently of the ML model that otherwise determines which users see which promotions. Thus, rather than relying on ML recommendations, the system adds a layer of deterministic control that ensures that provider's do not exceed predefined STS ratios, regardless of the ML model's outputs.

To achieve this, the system can utilize a real-time data ingestion pipeline. The data ingestion pipeline may continuously collect spend and sales data across the software application or digital marketplace. The spend and sales data can be aggregated for each provider on a daily basis and stored in a low-latency database, such as Redis or Cassandra. Updates to the database may occur as frequently as every 90 seconds. This near real-time aggregation of the spend and sales data can ensure that the system has an up-to-date view of each provider's daily spend and sales totals.

Additionally, the system may implement dual-threshold eligibility logic with anti-flapping protection. The dual-threshold eligibility logic may refer to a control mechanism that uses two thresholds to determine when a provider is eligible to continue serving promotions, and when those promotions should be disabled due to excessive spend relative to sales (the STS ratio). Conversely, anti-flapping protection may refer to a safeguard against rapid, repeated toggling (on/off) of promotion eligibility that may occur if only a single threshold were to be used.

To implement the dual-threshold eligibility logic with anti-flapping protection, the system may implement, at regular intervals, such as every 10 minutes, a scheduled job that reviews each provider's current-day STS ratio and can apply two configurable thresholds. The first threshold may be a disable threshold (e.g., 10% STS). This, if a provider's STS ratio reaches or exceeds the disable threshold, promotional campaigns for that merchant can be suspended. For example, no further promotions may delivered for the remainder of the day unless eligibility is restored. The second threshold may be a re-enable threshold (e.g., 8% STS). To avoid rapid toggling (flapping) between enabled and disabled states, the system may only restore promotion delivery after the provider's STS ratio falls below the re-enable threshold.

This hysteresis mechanism can ensure stability such that brief, minor fluctuations around a threshold do not repeatedly turn promotions on and off. For example, if a merchant's STS ratio hits 11% (above the disable threshold), promotions can be disabled and, if the STS ratio later drops to 9%, promotions can remain disabled. But, if the STS ratio drops to 7.5% (below the re-enable threshold) the promotions may be re-enabled.

Once eligibility is determined, the system can persist a Boolean flag for each provider, such as in a distributed database like Cassandra and potentially with a caching layer. This eligibility flag can serve as a deterministic criterion in the promotion-serving path. For example, if the flag is set to ineligible, promotions for that provider can be suppressed, regardless of what the ML model might otherwise recommend.

Furthermore, to further prevent erroneous disabling of promotions due to natural fluctuations, which may occur early in the day when sales volume is low and a single order or redemption could spike the STS ratio, the system can applies a minimum daily sales threshold.

Promotions may not be disabled for provider's whose daily sales have not yet reached the sales threshold, thus preventing spurious or premature enforcement of the promotional spending constraint.

### A. STS Ratio Cap and Problems in Implementation

A real-time spend-to-sales (STS) ratio cap in the serving flow for what is pushed to user devices can proceed as follow. For a given store, if the ratio of their promotion campaign spend to their total sales that day exceeds a certain threshold, the system can no longer serve webpage or native applications pages for promotional campaigns until the next day. However, implementing the STS ratio cap in the machine learning (ML) layer may be result in inaccurate or delayed suspension of promotional campaigns. For example, iff the ML model runs an offline job to refresh feature values (e.g., provider sales and promotional spending) used for prediction, the job may only run once a day and may therefore use data that has up to 24 hrs of lag, resulting in a total lag can be 48 hours.

### B. Dynamic Control of Serving Flow

When the periodic, such as daily, STS ratio of a promotion campaign provided by a provider is too high (above the disable threshold), the system may stop serving promotional campaigns on the store until STS has recovered below a threshold (the re-enable threshold). The disable and re-enable thresholds can be globally defined and easily configurable

### 1. System

In some implementations, the technique for controlling promotional spend can be constructed as a real-time, automated mechanism that enforces absolute upper bounds on the daily Spend-to-Sales (STS) ratio for each merchant store. This architecture can be referred to as a hard cap system and can complement the feedback control mechanism by providing a safety mechanism that prevents providers from exceeding a predefined maximum spend ratio, regardless of fluctuations in sales or promotional activity. The hard cap system can operate independently of the ML model's predictions, acting directly in the serving flow to disable promotional delivery when the observed STS ratio surpasses a threshold.

The hard cap system can ingest real-time or near-real time sales and promotional spend data for each provider, thereby aggregating these metrics in near real-time. In some embodiments, a streaming pipeline is used to collect, deduplicate, and serve accurate performance metrics. The pipeline may update the STS ratio for each store every few minutes, such as every 10 minutes, to enable the hard cap system to respond promptly to changes in store activity. The hard cap system may utilize a storage medium such as a Redis database or a low-latency cache to persist the eligibility state of each provider, allowing the overall system to efficiently read and write eligibility flags for promotional delivery.

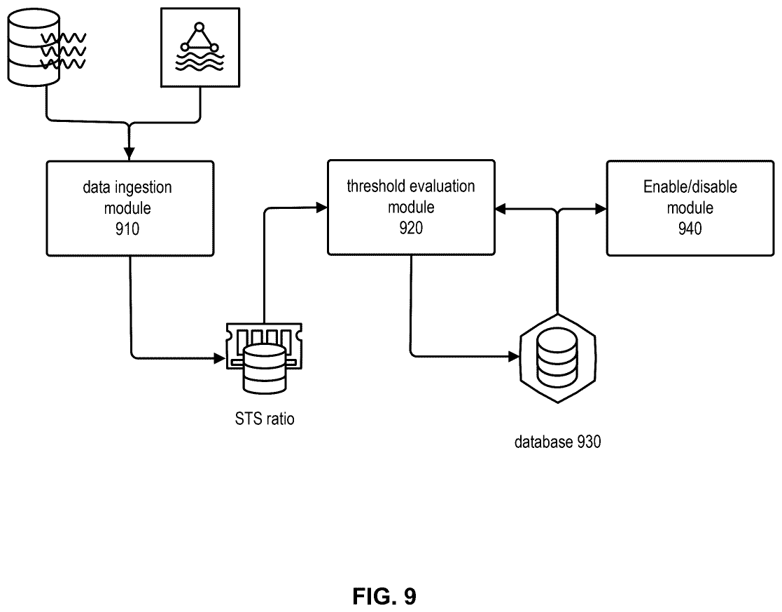

FIG. 9 illustrates the architecture and flow of the hard cap system. FIG. 9 includes components such as a data ingestion module 910, which can receive receives sales and spend data from provider endpoints. The data ingestion module 910 may processes the data and compute a current STS ratio for each provider. A threshold evaluation module 920 may then compare the computed STS ratio against two configurable thresholds:a disable threshold (e.g., 10% STS) and a re-enable threshold (e.g., 8% STS). The disable threshold may determine when promotional delivery is turned off for a store, while the re-enable threshold can ensure that delivery is resumed after the STS ratio drops below the lower bound, thereby preventing rapid oscillation or “flapping” in eligibility. An enable/disable module 940 can perform the enabling or disabling of the serving of application pages that include a promotion.

In some embodiments, the eligibility state for each store is persisted as a boolean flag in a distributed database 930, which may be implemented using Cassandra or a similar technology. This flag may be read as a deterministic criterion in the promotion serving path to ensure that promotion campaigns for ineligible providers are suppressed, regardless of ML model outputs or other system recommendations. The eligibility state may be updated periodically based on the latest STS ratio calculations, providing a robust mechanism for enforcing real-time spend constraints.

The hard cap system can incorporate anti-flapping logic, where eligibility is not toggled on or off based solely on the current STS ratio. Instead, the hard cap system can maintain memory of the eligibility state and apply hysteresis to prevent rapid transitions. For example, if the STS ratio rises above the disable threshold, promotional delivery is disabled and remains off until the ratio falls below the re-enable threshold, even if the ratio briefly fluctuates in between. This approach ensures stable operation and avoids disruptive toggling that could impact merchant experience or promotional effectiveness.

In some implementations, the system may use a minimum daily sales threshold to prevent spurious disabling of promotional delivery due to low-volume STS spikes early in the day. For example, for stores with insufficient sales data, global defaults or conservative parameters may be applied to ensure that the hard cap mechanism does not penalize providers due to a lack of activity or data volatility.

The architecture illustrated in FIG. 9 can be designed for high scalability, accommodating thousands or even hundreds of thousands of providers with individualized eligibility flags and real-time spend monitoring. The control logic of the architecture shown in FIG. 9 may operate at both the global and provider level, with parameters tuned for each granularity. For instance, global-level STS ratios can exhibit lower noise and more stable metrics, allowing for broader policy enforcement, while store-level ratios may require more nuanced, noise-adaptive control.

In some implementations, the hard cap system can be integrated with the ML model for predicting eligibility's feature store, thereby ensuring that eligibility flags are available for batch and real-time inference. When a store's eligibility flag is false, the ML model may suppresses promotional recommendations, overriding any predictions or scoring logic that might otherwise allocate promotional spending. This, in turn, can facilitate compliance with daily spend constraints and can provide providers with predictable, bounded exposure to promotional costs.

The hard cap technique described herein can be extended to support additional guardrails, such as minimum spend thresholds or dynamic adjustment of thresholds based on market conditions. For example, the system may automatically lower disable thresholds during periods of high demand volatility or raise them when aggregate marketplace metrics are stable. This adaptive approach can enhance merchant protection and support broader adoption of automated promotional allocation systems.

### 2. Anti-Flapping

To prevent rapid and potentially disruptive toggling (“flapping”) of promotional eligibility, the system can maintains a memory of each store's current eligibility state. For example, if the disable threshold for the spend-to-sales (STS) ratio is set at 10% and the re-enable threshold at 8%, the system can track whether a Smart Campaign (SC) is enabled or disabled over time. In one scenario, the SC is enabled at 9% STS at 5:00 PM, becomes disabled when the ratio jumps to 11% at 5:30 PM, and remains disabled even if the ratio drops back to 9% at 6:00 PM. In another scenario, the SC remains enabled throughout minor fluctuations, staying enabled at 9% at 5:00 PM, 8.5% at 5:30 PM, and 9% at 6:00 PM. These examples illustrate that observing the STS ratio at a single time point is insufficient to determine the appropriate state. Instead, the system can persist and reference the current eligibility state to ensure stable and predictable promotional delivery, effectively implementing anti-flapping protection and preventing unnecessary oscillation of eligibility status for merchants or stores.

### VI. Example Systems and Devices

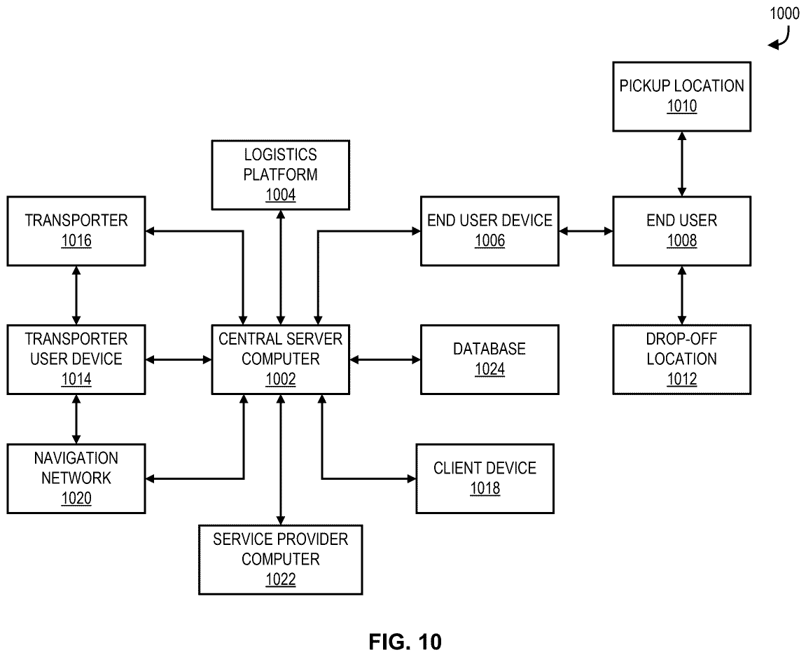

FIG. 10 shows a system 1000 according to embodiments of the disclosure. The system of FIG. 10 includes a central server computer 1002, a logistics platform 1004, an end user device 1006, an end user 1008, a pickup location 1010, a drop-off location 1012, a transporter user device 1014, a transporter 1016, a client device 1018, a navigation network 1020, a service provider computer 1022, and a database 1024.

The central server computer 1002 can be in operative communication with the logistics platform 1004, the end user device 1006, the transporter user device 1014, the client device 1018, the navigation network 1020, the service provider computer 1022, and the database 1024. The transporter user device 1014 can be in operative communication with the navigation network 1020.

For simplicity of illustration, a certain number of components are shown in FIG. 10. It is understood, however, that embodiments of the invention may include more than one of each component. In addition, some embodiments of the invention may include fewer than or greater than all of the components shown in FIG. 10. For example, although FIG. 10 shows one transporter 1016, there can be two, three, or more transporters, transporter user devices, etc.

Messages between the devices and the computers in the system 1000 in FIG. 10 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 1002 can include a server computer that can facilitate in the fulfillment of fulfillment requests received from the end user device 1006. For example, the central server computer 1002 can identify the transporter 1016 (from among many candidate transporters) operating the transporter user device 1014 as being suitable for satisfying the fulfillment request. The central server computer 1002 can identify the transporter user device 1014 that can satisfy the fulfillment request based on any suitable criteria (e.g., transporter location, service provider location, end user destination, end user location, transporter mode of transportation, etc.).

The central server computer 1002 can receive data relating to a delivery order of items from the service provider computer 1022 to the end user 1008 at the drop-off location 1012. The central server computer 1002 can determine a route for delivery of the delivery order. The central server computer 1002 can present the routes to a plurality of transporter user devices and/or transporters. The central server computer 1002 can receive acceptances from the transporter 1016 that will deliver the items from the pickup location 1010 to the drop-off location 1012.

The logistics platform 1004 can include a location determination system, which can determine the locations of various user devices such as transporter user devices (e.g., the transporter user device 1014) and end user devices (e.g., the end user device 1006). The logistics platform 1004 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 1004 can be part of the central server computer 1002 or can be a system that is separate from the central server computer 1002.

The end user device 1006 can include a device operated by the end user 1008. The end user devices 1006 can generate and provide fulfillment request messages to the central server computer 1002. The fulfillment request message can indicate that the request (e.g., a request for a service) can be fulfilled by the service provider computer 1022. For example, the fulfillment request message can be generated based on a cart selected at checkout during a transaction using a central server computer application installed on the end user device 1006. The fulfillment request message can include one or more items from the selected cart.

The end user device 1006 can provide a fulfillment request message to the central server computer 1002 that indicates that the end user device 1006 is requesting that the transporter 1016 pickup an item from the pickup location 1010 (e.g., end user's 1008 location) and deliver the item to the drop-off location 1012 (e.g., the service provider computer's 1022 location).

The pickup location 1010 can be a location in which items are stored. In the context of an outbound delivery from an end user at an end user location, examples of the pickup location 1010 may be a house or an apartment, a mailbox, a service provider location (e.g., a retail store, a grocery store, a dry cleaning store), a pickup hub, etc. Items can first be obtained from a pickup location 1010 and then be transported to the drop-off location 1012. Examples of the drop-off location 1012 can be similar to the pickup location 1010, such as a house or apartment, a mailbox, a retail store, a grocery store, a dry cleaning store, a pickup hub, etc. In one example, the pickup location 1010 can be a pizza parlor from which the end user 1008 orders a pizza. The drop-off location 1012 can be an apartment in which the end user 1008 resides.

The transporter user device 1014 can include a device operated by the transporter 1016. The transporter user device 1014 can include a smartphone, a wearable device, a personal assistant device, etc. The transporter 1016 can accept an end user's fulfillment request via an acceptance message. For example, the transporter user device 1014 can generate and transmit a request to fulfil a particular end user's fulfillment request to the central server computer 1002. The central server computer 1002 can notify the transporter user device 1014 of the fulfillment request. The transporter user device 1014 can respond to the central server computer 1002 with a request to perform the delivery to the end user as indicated by the fulfillment request.

In some embodiments, the transporter 1016 can be an operator of a vehicle. In other embodiments, the transporter 1016 can be a vehicle that can be operated by an operator or can be autonomous. The vehicle can include a car, a truck, a van, a motorcycle, a bicycle, a drone, or other vehicle.

The client device 1018 can request information from the central server computer 1002. The client device 1018 can be operated by a user that requests information from the central server computer 1002 related to a journey. In some embodiments, the client device 1018 can be the transporter user device 1014. In other embodiments, the client device 1018 can be the end user device 1006.

The navigation network 1020 can provide navigational directions to the transporter user device 1014. For example, the transporter user device 1014 can obtain a location from the central server computer 1002. The location can be a service provider parking location, a service provider location, an end user parking location, an end user location, etc. The navigation network 1020 can provide navigational data to the location. For example, the navigation network 1020 can be a global positioning system that provides location data to the transporter user device 1014.

The service provider computer 1022 include computers operated by a service provider. For example, the service provider computer 1022 can be a food provider computer that is operated by a food provider. The service provider computer 1022 can offer to provide services to the end user 1008 of the end user device 1006. In embodiments of the invention, the service provider computer 1022 can receive requests to prepare one or more items for delivery from the central server computer 1002. The service provider computer 1022 can initiate the preparation of the one or more items that are to be delivered to the end user 1008 of the end user device 1006 by the transporter 1016 of the transporter user device 1014.

The database 1024 can include any suitable database. The database may be a conventional, fault tolerant, relational, scalable, secure database such as those commercially available from Oracle™ or Sybase™. The database 1024 can store supplemental information (e.g., an image, a text message, etc.), the location datum (e.g., a location that includes a latitude and longitude, etc.), and the time datum (e.g., a specific time).

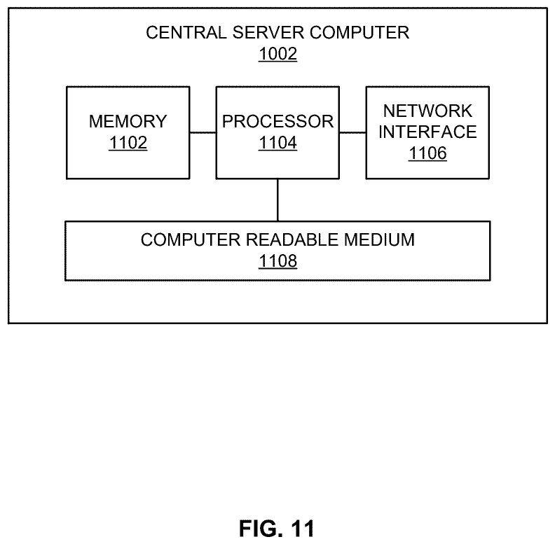

FIG. 11 shows a block diagram of a central server computer 1102 according to embodiments. The central server computer 1102 may comprise a processor 1104. The processor 1104 may be coupled to a memory 1102, a network interface 1106, and a computer readable medium 1108. The computer readable medium 1108 can comprise a one or more modules.

The memory 1102 can be used to store data and code. For example, the memory 1102 can store images, text data, machine learning models, machine learning model data, etc. The memory 1102 may be coupled to the processor 1104 internally or externally (e.g., cloud based data storage), and may comprise any combination of volatile and/or non-volatile memory, such as RAM, DRAM, ROM, flash, or any other suitable memory device.

The computer readable medium 1108 may comprise code, executable by the processor 1104, for performing methods described herein.

The network interface 1106 may include an interface that can allow the central server computer 1102 to communicate with external computers. The network interface 1006 may enable the central server computer 1102 to communicate data to and from another device. Some examples of the network interface 1106 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 1106 may include Wi-Fi™. Data transferred via the network interface 1106 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 1106 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

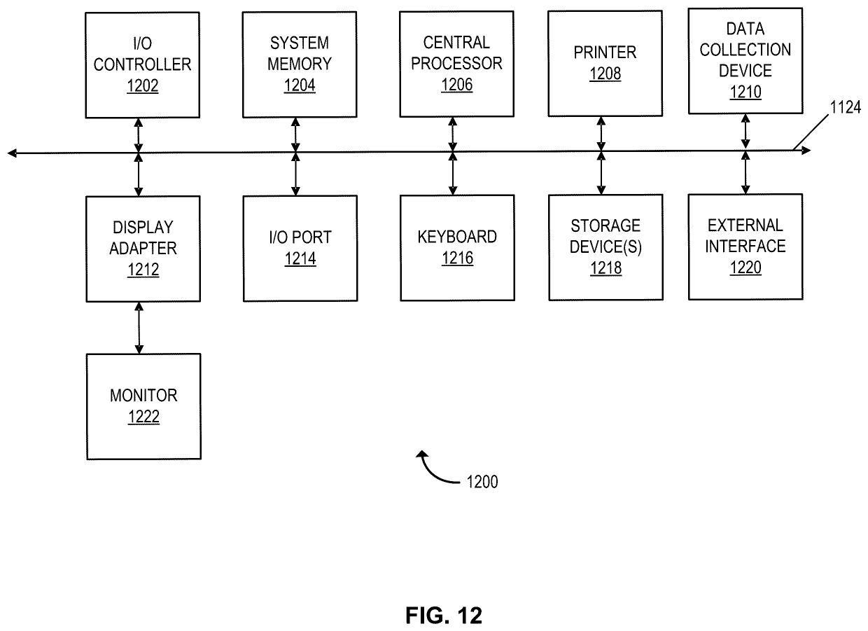

Any of the computer systems mentioned herein may utilize any suitable number of subsystems. Examples of such subsystems are shown in FIG. 12 in computer system 1200. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 12 are interconnected via a system bus 1224. Additional subsystems such as a printer 1208, keyboard 1216, storage device(s) 1218, monitor 1222 (e.g., a display screen, such as an LED), which is coupled to display adapter 1212, and others are shown. Peripherals and input/output (I/O) devices, which couple to I/O controller 1102, can be connected to the computer system by any number of means known in the art such as input/output (I/O) port 1214 (e.g., USB, FireWire®). For example, I/O port 1214 or external interface 1220 (e.g., Ethernet, Wi-Fi, etc.) can be used to connect computer system 1200 to a wide area network such as the Internet, a mouse input device, or a scanner. The interconnection via system bus 1224 allows the central processor 1206 to communicate with each subsystem and to control the execution of a plurality of instructions from system memory 1204 or the storage device(s) 1218 (e.g., a fixed disk, such as a hard drive, or optical disk), as well as the exchange of information between subsystems. The system memory 1204 and/or the storage device(s) 1218 may embody a computer readable medium. Another subsystem is a data collection device 1210, such as a camera, microphone, accelerometer, and the like. Any of the data mentioned herein can be output from one component to another component and can be output to the user.

A computer system can include a plurality of the same components or subsystems, for example, connected together by external interface 1220, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device (e.g., as firmware) or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Although the steps in the flowcharts and process flows described above are illustrated or described in a specific order, it is understood that embodiments of the invention may include methods that have the steps in different orders. In addition, steps may be omitted or added and may still be within embodiments of the invention.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A method comprising:
obtaining data associated with a plurality of users of a software application, the data being indicative of a plurality of orders placed by the plurality of users using the software application, each of the plurality of orders being associated with a resource provider;
generating, based on the data, a user feature vector for each of the plurality of users;
inputting the user feature vector for each of the plurality of users into a first machine learning model;
outputting, by the first machine learning model and based on the user feature vector for reach of the plurality of users, a user-specific incremental interaction value for each of the plurality of users;
generating, using a second machine learning model, an incremental interaction value for each of a set of order frequency levels; and
determining, based on the incremental interaction value for each of the set of order frequency values and based on the user-specific incremental interaction value for each of the plurality of users, a plurality of user-specific provider-specific incremental interaction values.

2. The method of claim 1, further comprising:
executing a grid search to determine an optimal interaction amount for each of the plurality of users relative to the resource provider based on the plurality of user-specific provider-specific incremental interaction values.

3. The method of claim 2, further comprising:
generating a ranking of the plurality of users relative to the resource provider based on an objective value determined via the grid search; and
calculating a cumulative interaction value for a subset of highest ranked users based on the ranking of the plurality of users relative to the resource provider and using the optimal interaction amount for each of the plurality of users in the subset of the highest ranked users, wherein the cumulative interaction value is less than or equal to a constraint.

4. The method of claim 2, further comprising:
generating a ranking of the plurality of users relative to the resource provider based on a subset of the plurality of user-specific provider-specific incremental interaction values associated with each of the plurality of users and the resource provider; and
calculating a cumulative promotion spending for a subset of highest ranked users based on the ranking of the users relative to the resource provider and using the optimal interaction amount for each of the subset of the highest ranked users, wherein the cumulative promotion spending is less than or equal to a constraint.

5. The method of claim 1, further comprising:
determining, using a third machine learning model, an individual amount offered for each of the plurality of users relative to the resource provider based on the plurality of user-specific provider-specific incremental interaction values and based on one or more hyperparameters for a total amount provided to the plurality of users.

6. The method of claim 5, wherein the one or more hyperparameters for the total amount provided to the users comprise at least one of: a maximum amount or a ratio of a conversion amount to the total amount.

7. The method of claim 5, further comprising performing clipping to limit a maximum change in the one or more hyperparameters from one time period to a next time period.

8. The method of claim 5, further comprising:
suppressing the individual amount offered for each of the plurality of users relative to the resource provider in response to a cumulative amount reaching a disable threshold.

9. The method of claim 8, wherein the disable threshold is dynamically configured based on a statistical analysis of historical total-to-conversion ratios for the resource provider, such that the disable threshold is set at a value corresponding to a selected number of standard deviations above an average total-to-conversion ratio.

10. The method of claim 8, further comprising: re-enabling the individual amount offered for each of the plurality of users relative to the resource provider after the cumulative amount falls below a re-enable threshold, wherein the re-enable threshold is less than the disable threshold.

11. The method of claim 8, wherein the cumulative amount is aggregated in real time from conversion events, and eligibility for offering individual amounts is updated at a periodic interval based on the cumulative amount.

12. The method of claim 8, further comprising:
persisting an eligibility flag for the resource provider in a distributed database, and
reading the eligibility flag as a deterministic criterion in a promotional serving path, thereby suppressing automated promotional recommendations for the resource provider when the cumulative amount exceeds the disable threshold.

13. A system comprising:
one or more processors; and
one or more memories storing instructions that are executable by the one or more processors for causing the one or more processors to perform operations including:
obtaining data associated with a plurality of users of a software application, the data being indicative of a plurality of orders placed by the plurality of users using the software application, each of the plurality of orders being associated with a resource provider;
generating, based on the data, a user feature vector for each of the plurality of users;
inputting the user feature vector for each of the plurality of users into a first machine learning model;
outputting, by the first machine learning model and based on the user feature vector for reach of the plurality of users, a user-specific incremental interaction value for each of the plurality of users;
generating, using a second machine learning model, an incremental interaction value for each of a set of order frequency levels; and
determining, based on the incremental interaction value for each of the set of order frequency values and based on the user-specific incremental interaction value for each of the plurality of users, a plurality of user-specific provider-specific incremental interaction values.

14. The system of claim 13, wherein the operations further comprise:
executing a grid search to determine an optimal interaction amount for each of the plurality of users relative to the resource provider based on the plurality of user-specific provider-specific incremental interaction values.

15. The system of claim 14, wherein the operations further comprise:
generating a ranking of the plurality of users relative to the resource provider based on an objective value determined via the grid search; and
calculating a cumulative interaction value for a subset of highest ranked users based on the ranking of the plurality of users relative to the resource provider and using the optimal interaction amount for each of the plurality of users in the subset of the highest ranked users, wherein the cumulative interaction value is less than or equal to a constraint.

16. The system of claim 14, wherein the operations further comprise:
generating a ranking of the plurality of users relative to the resource provider based on a subset of the plurality of user-specific provider-specific incremental interaction values associated with each of the plurality of users and the resource provider; and
calculating a cumulative promotion spending for a subset of highest ranked users based on the ranking of the users relative to the resource provider and using the optimal interaction amount for each of the subset of the highest ranked users, wherein the cumulative promotion spending is less than or equal to a constraint.

17. The system of claim 14, wherein the operations further comprise:
determining, using a third machine learning model, an individual amount offered for each of the plurality of users relative to the resource provider based on the plurality of user-specific provider-specific incremental interaction values and based on one or more hyperparameters for a total amount provided to the plurality of users.

18. The system of claim 17, wherein the one or more hyperparameters for the total amount provided to the users comprise at least one of: a maximum amount or a ratio of a conversion amount to the total amount.

19. The system of claim 17, wherein the operations further comprise:
performing clipping to limit a maximum change in the one or more hyperparameters from one time period to a next time period.

20. The system of claim 17, wherein the operations further comprise:
suppressing the individual amount offered for each of the plurality of users relative to the resource provider in response to a cumulative amount reaching a disable threshold.
